(19) United States
(12) Patent Application Publication
(10) Pub. No.: US 2017/0265210 A1
(43) Pub. Date: Sep. 14, 2017

(54) TECHNIQUES FOR SEPARATE SCHEDULING AND GROUPING IN WLAN

(71) Applicant: QUALCOMM Incorporated, San Diego, CA (US)

(72) Inventors: Xiaolong HUANG, San Jose, CA (US); Srinivas KATAR, Fremont, CA (US); Hao ZHU, Milpitas, CA (US); James CHO, Mountain View, CA (US); Alireza RAISSINIA, Monte Sereno, CA (US); Chao ZOU, San Jose, CA (US); Sabita NAHATA, Newark, CA (US); Guido Robert FREDERIKS, Watsonville, CA (US); Raja BANERJEA, San Jose, CA (US); Chao CHENG, Santa Clara, CA (US); Ning ZHANG, Saratoga, CA (US); Zhanfeng JIA, Belmont, CA (US)

(21) Appl. No.: 15/456,128

(22) Filed: Mar. 10, 2017

Related U.S. Application Data
(60) Provisional application No. 62/308,019, filed on Mar. 14, 2016.
(60) Provisional application No. 62/356,304, filed on Jun. 29, 2016.

(51) Int. Cl. H04W 72/12; H04L 5/00; H04W 72/04

(52) U.S. Cl. CPC H04W 72/121; H04W 72/1247; H04W 72/0453; H04L 5/0007; H04W 72/1252; H04W 84/12

(57) ABSTRACT

Apparatuses and methods for separately scheduling and grouping multiple wireless local area network (WLAN) users are disclosed. The apparatuses and methods include scheduling, at an access point (AP), multiple wireless stations (STAs) associated with the AP; identifying based at least in part on the ranking, a group of STAs from the STAs for transmission of data over a single orthogonal frequency-division multiple access (OFDMA) frame in a WLAN; and providing information resulting from scheduling the STAs and identifying the group of STAs to at least one of the STAs. In others aspects, the apparatuses and methods include receiving at an STA from an AP, scheduling information for a group of STAs including the STA; and transmitting based on the scheduling information, data over an OFDMA frame in an unlicensed or shared spectrum, the STA having a traffic load different from the traffic load of the at least one additional STA.

### CLAIM OF PRIORITY UNDER 35 U.S.C. §119

The present Application for patent claims priority to U.S. Provisional Application No. 62/308,019 entitled “TECHNIQUES FOR SEPARATE SCHEDULING AND GROUPING IN WLAN” filed Mar. 14, 2016, and U.S. Provisional Application No. 62/356,304 entitled “HEURISTIC-BASED ALLOCATION OF RESOURCE UNITS” filed Jun. 29, 2016, and both applications are assigned to the assignee hereof and hereby expressly incorporated by reference herein.

### BACKGROUND

Aspects of this disclosure relate generally to telecommunications, and more particularly to techniques for separately scheduling and grouping multiple wireless local area network (WLAN) users.

The deployment of WLANs in the home, the office, and various public facilities is commonplace today. Such networks typically employ a wireless access point (AP) that connects a number of wireless stations (STAs) in a specific locality (e.g., home, office, public facility, etc.) to another network, such as the Internet or the like. A set of STAs can communicate with each other through a common AP in what is referred to as a basic service set (BSS). Nearby BSSs may have overlapping coverage areas and such BSSs may be referred to as overlapping BSSs or OBSSs.

In some WLANs, such as those based on Institute of Electrical and Electronics Engineers (IEEE) 802.11ac, for example, a multi-user multiple-input-multiple-output (MU-MIMO) scheduler in an AP may be configured to optimize the efficiency with which resources associated with the media access control (MAC) layer are utilized by the network, sometimes simply referred to as the MAC efficiency. Such a scheduler, however, may not be configured to address the latency and throughput performance of individual STAs. With the number of STAs being scheduled by a single AP increasing, and with a large number of those STAs having diverse traffic loads, patterns, quality-of-service (QoS) requirements, and conditions, the operations of the scheduler may have a significant impact on network capacity and on an individual STA's packet delay and throughput.

Accordingly, in such scenarios, it may be desirable to have a scheduler architecture that allows for maximizing network capacity and that also provides, even when resource constraints are considered, a certain degree of fairness to an individual STA's data packet delay and throughput during wireless communications.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In accordance with an aspect, a method for wireless communications is described. The method can be used for scheduling and grouping multiple wireless local area network (WLAN) users (e.g., STAs). The described aspects include scheduling, at an access point (AP), multiple wireless stations (STAs) associated with the AP, the scheduling including ranking each of the multiple STAs based at least in part on performance requirements of the respective STA. The described aspects further include identifying based at least in part on the ranking, a group of STAs from the multiple STAs for transmission of data over a single orthogonal frequency-division multiple access (OFDMA) frame in spectrum WLAN. The described aspects further include providing information to each of the multiple STAs resulting from scheduling the multiple STAs and identifying the group of STAs to at least one of the multiple STAs.

In another aspect, an apparatus for wireless communications may include a transceiver, a memory; and at least one processor coupled to the memory. The apparatus can be used for scheduling and grouping multiple WLAN users (e.g., STAs). The described aspects schedule, at an AP, multiple STAs associated with the AP, the scheduling including ranking each of the multiple STAs based at least in part on performance requirements of the respective STA. The described aspects further identify based at least in part on the ranking, a group of STAs from the multiple STAs for transmission of data over a single OFDMA frame in spectrum WLAN. The described aspects further provide information to each of the multiple STAs resulting from scheduling the multiple STAs and identifying the group of STAs to at least one of the multiple STAs.

In another aspect, a computer-readable medium may store computer executable code for wireless communications. The computer-readable medium can be used for scheduling and grouping multiple WLAN users (e.g., STAs). The described aspects include code for scheduling, at an AP, multiple STAs associated with the AP, the scheduling including ranking each of the multiple STAs based at least in part on performance requirements of the respective STA. The described aspects further include identifying based at least in part on the ranking, a group of STAs from the multiple STAs for transmission of data over a single OFDMA frame in spectrum WLAN. The described aspects further include code for providing information to each of the multiple STAs resulting from scheduling the multiple STAs and identifying the group of STAs to at least one of the multiple STAs.

In another aspect, an apparatus for wireless communications is described. The apparatus can be used for scheduling and grouping multiple WLAN users (e.g., STAs). The described aspects include means for scheduling, at an AP, multiple STAs associated with the AP, the scheduling including ranking each of the multiple STAs based at least in part on performance requirements of the respective STA. The described aspects further include means for identifying based at least in part on the ranking, a group of STAs from the multiple STAs for transmission of data over a single OFDMA frame in spectrum WLAN. The described aspects further include means for providing information to each of the multiple STAs resulting from scheduling the multiple STAs and identifying the group of STAs to at least one of the multiple STAs.

In accordance with an aspect, a method for wireless communications is described. The method can be used for communicating in a WLAN based on information corresponding to a scheduling and grouping of multiple WLAN users (e.g., STAs). The described aspects include receiving at a wireless station from an access point, scheduling information for a group of wireless stations including the wireless station. The described aspects further include transmitting based on the scheduling information, data over an OFDMA frame in an unlicensed or shared spectrum, the data being transmitted in the OFDMA frame along with data from at least one additional wireless station from the group of wireless stations, and the wireless station having a traffic load different from the traffic load of the at least one additional wireless station.

In another aspect, an apparatus for wireless communications may include a transceiver, a memory; and at least one processor coupled to the memory. The apparatus can be used for communicating in a WLAN based on information corresponding to a scheduling and grouping of multiple WLAN users (e.g., STAs). The described aspects receive at a wireless station from an access point, scheduling information for a group of wireless stations including the wireless station. The described aspects further transmit based on the scheduling information, data over an OFDMA frame in an unlicensed or shared spectrum, the data being transmitted in the OFDMA frame along with data from at least one additional wireless station from the group of wireless stations, and the wireless station having a traffic load different from the traffic load of the at least one additional wireless station.

In another aspect, a computer-readable medium may store computer executable code for wireless communications corresponding to a scheduling and grouping of multiple users. The computer-readable medium can be used for communicating in a WLAN based on information corresponding to a scheduling and grouping of multiple WLAN users (e.g., STAs). The described aspects include code for receiving at a wireless station from an access point, scheduling information for a group of wireless stations including the wireless station. The described aspects further include code for transmitting based on the scheduling information, data over an OFDMA frame in an unlicensed or shared spectrum, the data being transmitted in the OFDMA frame along with data from at least one additional wireless station from the group of wireless stations, and the wireless station having a traffic load different from the traffic load of the at least one additional wireless station.

In another aspect, an apparatus for wireless communications is described. The apparatus can be used for communicating in a WLAN based on information corresponding to a scheduling and grouping of multiple WLAN users (e.g., STAs). The described aspects include means for receiving at a wireless station from an access point, scheduling information for a group of wireless stations including the wireless station. The described aspects further include means for transmitting based on the scheduling information, data over an OFDMA frame in an unlicensed or shared spectrum, the data being transmitted in the OFDMA frame along with data from at least one additional wireless station from the group of wireless stations, and the wireless station having a traffic load different from the traffic load of the at least one additional wireless station.

Various aspects and features of the disclosure are described in further detail below with reference to various examples thereof as shown in the accompanying drawings. While the present disclosure is described below with reference to various examples, it should be understood that the present disclosure is not limited thereto. Those of ordinary skill in the art having access to the teachings herein will recognize additional implementations, modifications, and examples, as well as other fields of use, which are within the scope of the present disclosure as described herein, and with respect to which the present disclosure may be of significant utility.

### BRIEF DESCRIPTION OF THE DRAWINGS

The features, nature, and advantages of the present disclosure will become more apparent from the detailed description set forth below when taken in conjunction with the drawings in which like reference characters identify correspondingly throughout, where dashed lines may indicate optional components or actions, and wherein:

FIG. 1 is a conceptual diagram illustrating an example of a wireless local area network (WLAN) deployment.

FIG. 2A is a schematic diagram illustrating an example of a scheduler architecture for scheduling and grouping multiple users during wireless communications in accordance with various aspects of the present disclosure.

FIG. 2B is a schematic diagram illustrating an example of a communication network including aspects of a wireless station and an access point in a WLAN in accordance with various aspects of the present disclosure.

FIG. 2C is a schematic diagram illustrating an example of a system operable to allocate RUs during wireless communications in accordance with various aspects of the present disclosure.

FIG. 3A is a diagram illustrating an example related to operation of the system of FIG. 2C in accordance with various aspects of the present disclosure.

FIG. 3B is a diagram illustrating an example related to operation of the system of FIG. 2C in accordance with various aspects of the present disclosure.

FIG. 3C is a diagram illustrating an example related to operation of the system of FIG. 2C in accordance with various aspects of the present disclosure.

FIG. 4 is a diagram illustrating an example of allocating RUs in accordance with various aspects of the present disclosure.

FIG. 5 is a diagram illustrating an example of RU allocation heuristics in accordance with various aspects of the present disclosure.

FIG. 6 is a diagram illustrating an example of a physical layer convergence protocol (PLCP) protocol data unit (PPDU) length adjustment in accordance with various aspects of the present disclosure.

FIG. 7 is a flow diagram illustrating an example method of separately scheduling and grouping multiple users during wireless communications in accordance with various aspects of the present disclosure.

FIG. 8 is a flow diagram illustrating an example method of bisectional grouping in order to adjust a length of a physical layer convergence procedure (PLCP) protocol data unit (PPDU) for identifying a group of users in accordance with various aspects of the present disclosure.

FIG. 9 is a flow diagram illustrating an example method of proportional resource unit allocation for identifying a group of users in accordance with various aspects of the present disclosure.

FIG. 10 is a flow diagram illustrating an example method of communicating in a WLAN based on information corresponding to a scheduling and grouping of multiple users in accordance with various aspects of the present disclosure.

FIG. 11 is a flow diagram illustrating an example method of allocating RUs in accordance with various aspects of the present disclosure.

FIG. 12 is a flow diagram illustrating an example method of allocating RUs in accordance with various aspects of the present disclosure.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known components are shown in block diagram form in order to avoid obscuring such concepts. In an aspect, the term “component” as used herein may be one of the parts that make up a system, may be hardware or software, and may be divided into other components.

Aspects of the disclosure are provided in the following description and related drawings directed to specific disclosed aspects. Alternate aspects may be devised without departing from the scope of the disclosure. Additionally, well-known aspects of the disclosure may not be described in detail or may be omitted so as not to obscure more relevant details. Further, many aspects are described in terms of sequences of actions to be performed by, for example, elements of a computing device. It will be recognized that various actions described herein can be performed by specific circuits (e.g., application specific integrated circuits (ASICs)), by program instructions being executed by one or more processors, or by a combination of both. Additionally, these sequence of actions described herein can be considered to be embodied entirely within any form of computer readable storage medium having stored therein a corresponding set of computer instructions that upon execution would cause an associated processor to perform the functionality described herein. Thus, the various aspects of the disclosure may be embodied in a number of different forms, all of which have been contemplated to be within the scope of the claimed subject matter. In addition, for each of the aspects described herein, the corresponding form of any such aspects may be described herein as, for example, “logic configured to” perform the described action.

The present aspects generally relate to separately scheduling and grouping multiple users (e.g., multiple wireless stations associated with an access point) during wireless communications. In an aspect, for example, in some wireless communication networks, wireless stations (STAs) may communicate with one or more access points (APs). For example, in multi-user multiple-input, multiple-output (MU-MIMO) technology, an AP can transmit to and receive data from multiple STAs at the same time. Although the STAs need also support MU-MIMO to utilize it, they are not required to have multiple antennas. For current IEEE 802.11ac protocol enabled MU-MIMO schedulers, the media access control (MAC) efficiency of the network may be optimized, but the MU-MIMO schedulers do not address the individual latency and throughput performance. For IEEE 802.11ax, for example, an AP may need to potentially schedule up to 64×8 users (e.g., STAs) in one Physical Layer Convergence Protocol (PLCP) Protocol Data Unit (PPDU). In these instances, a large number of STAs are deployed within a network each of which have diverse traffic loads, traffic patterns, Quality-of-Service (QoS) requirements, and channel conditions. The IEEE 802.11ax scheduling may have significant impact on achievable capacity of the network and individual user data packet delay and throughput. Currently, the process of scheduling and grouping are dependent on one another, and so, when a large number of STAs are deployed within the network and require scheduling, latency and throughput performance issues arise. As such, there is a need to address the latency and throughput performance of individual STAs.

Accordingly, in some aspects, the present methods and apparatuses may provide an efficient solution, as compared to current solutions, by separately scheduling and grouping multiple users during wireless communications. In other words, in the present aspects, a device may be capable of separately scheduling and grouping multiple users to maximize network capacity while optimizing data packet delay and throughput. As such, the present aspects provide one or more mechanisms for scheduling, at an AP, multiple STAs associated with the AP, the scheduling including ranking each of the multiple STAs based at least in part on performance requirements of the respective STA. The present aspects further provide for identifying, separately from the scheduling and based at least in part on the ranking, a group of STAs from the multiple STAs for transmission of data over a single orthogonal frequency-division multiple access (OFDMA) frame in a WLAN. The present aspects further include providing information resulting from the scheduling and the identifying of the group of STAs.

Accordingly, in other aspects, the present methods and apparatuses may provide an efficient solution as compared to current solutions, by communicating in a WLAN based on information corresponding to a scheduling and grouping of multiple users. As such, the present aspects provide one or more mechanisms for receiving at a wireless station from an access point, scheduling information for a group of wireless stations including the wireless station. The present aspects further provide for transmitting based on the scheduling information, data over an OFDMA frame in a WLAN, the data being transmitted in the OFDMA frame along with data from at least one additional wireless station from the group of wireless stations, and the wireless station having a traffic load different from the traffic load of the at least one additional wireless station.

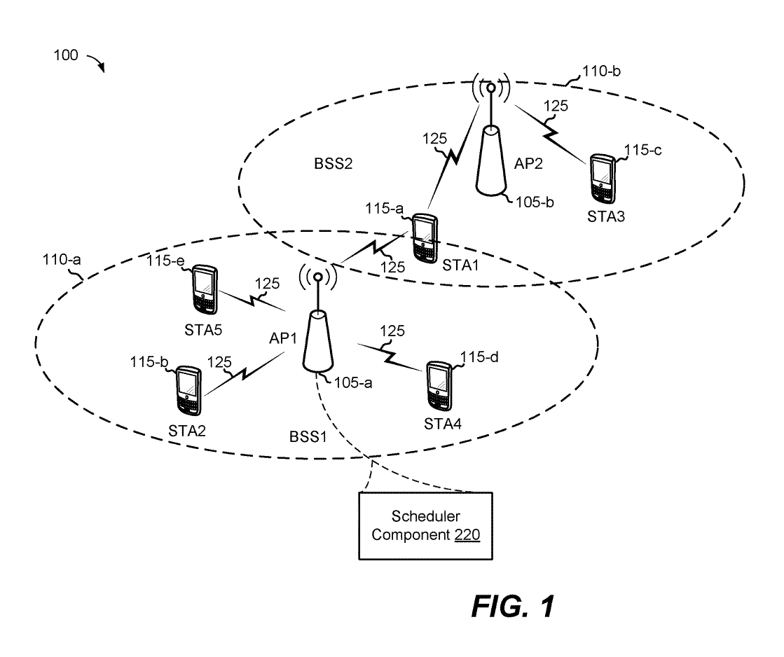

FIG. 1 is a wireless communication system 100 illustrating an example of a wireless local area network (WLAN) deployment in connection with various techniques described herein. The WLAN deployment may include one or more access points (APs) and one or more mobile stations (STAs) associated with a respective AP comprising a scheduler component, such as scheduler component 220 that is configured to separately schedule and group multiple users during wireless communications, as described further below. In this example, there are only two APs deployed for illustrative purposes: AP1 105-a in basic service set 1 (BSS1) and AP2 105-b in BSS2. AP1 105-a is shown having at least two associated STAs (STA1 115-a, STA2 115-b, STA4 115-d, and STA5 115-e) and coverage area 110-a, while AP2 105-b is shown having at least two associated STAs (STA1 115-a and STA3 115-c) and coverage area 110-b. In the example of FIG. 1, the coverage area of AP1 105-a overlaps part of the coverage area of AP2 105-b such that STA1 115-a is within the overlapping portion of the coverage areas. The number of BSSs, APs, and STAs, and the coverage areas of the APs described in connection with the WLAN deployment of FIG. 1 are provided by way of illustration and not of limitation. Moreover, aspects of the various techniques described herein are at least partially based on the example WLAN deployment of FIG. 1 but need not be so limited.

The APs (e.g., AP1 105-a and AP2 105-b) shown in FIG. 1 are generally fixed terminals that provide backhaul services to STAs within its coverage area or region. In some applications, however, the AP may be a mobile or non-fixed terminal. The STAs (e.g., STA1 115-a, STA2 115-b, STA3 115-c, STA4 115-d, and STA5 115-e) shown in FIG. 1, which may be fixed, non-fixed, or mobile terminals, utilize the backhaul services of their respective AP to connect to a network, such as the Internet. Examples of an STA include, but are not limited to: a cellular phone, a smart phone, a laptop computer, a desktop computer, a personal digital assistant (PDA), a personal communication system (PCS) device, a personal information manager (PIM), personal navigation device (PND), a global positioning system, a multimedia device, a video device, an audio device, a device for the Internet-of-Things (IoT), or any other suitable wireless apparatus requiring the backhaul services of an AP. An STA may also be referred to by those skilled in the art as: a subscriber station, a mobile unit, a subscriber unit, a wireless unit, a remote unit, a mobile device, a wireless device, a wireless communications device, a remote device, a mobile subscriber station, an access terminal, a mobile terminal, a wireless station, a remote terminal, a handset, a user agent, a mobile client, a client, user equipment (UE), or some other suitable terminology. An AP may also be referred to as: a base station, a base transceiver station, a radio base station, a radio transceiver, a transceiver function, a small cell, or any other suitable terminology. The various concepts described throughout this disclosure are intended to apply to all suitable wireless apparatus regardless of their specific nomenclature.

Each of STA1 115-a, STA2 115-b, STA3 115-c, STA4 115-d, and STA5 115-e may be implemented with a protocol stack. The protocol stack can include a physical layer for transmitting and receiving data in accordance with the physical and electrical specifications of the wireless channel, a data link layer for managing access to the wireless channel, a network layer for managing source to destination data transfer, a transport layer for managing transparent transfer of data between end users, and any other layers necessary or desirable for establishing or supporting a connection to a network.

Each of AP1 105-a and AP2 105-b can include software applications and/or circuitry to enable associated STAs to connect to a network via communications links 125. The APs can send frames to their respective STAs and receive frames from their respective STAs to communicate data and/or control information (e.g., signaling).

Each of AP1 105-a and AP2 105-b can establish a communications link 125 with an STA that is within the coverage area of the AP. Communications links 125 can comprise communications channels that can enable both uplink and downlink communications. When connecting to an AP, an STA can first authenticate itself with the AP and then associate itself with the AP. Once associated, a communications link 125 can be established between the AP and the STA such that the AP and the associated STA can exchange frames or messages through a direct communications channel.

While aspects of the present disclosure are described in connection with a WLAN deployment or the use of IEEE 802.11-compliant networks, those skilled in the art will readily appreciate, the various aspects described throughout this disclosure may be extended to other networks employing various standards or protocols including, by way of example, BLUETOOTH® (Bluetooth), HiperLAN (a set of wireless standards, comparable to the IEEE 802.11 standards, used primarily in Europe), and other technologies used in wide area networks (WAN)s, WLANs, personal area networks (PAN)s, or other suitable networks now known or later developed. Thus, the various aspects presented throughout this disclosure for scheduling and grouping users or STAs for data transmission over an OFDMA frame may be applicable to any suitable wireless network regardless of the coverage range and the wireless access protocols utilized.

In an aspect, an AP, such as AP1 105-a may communicate with multiple STAs, such as STAs 115-a, 115-b, 115-d, and 115-e using MU-MIMO. For example, AP1 105-a may schedule and group a subset of the STAs within proximity of AP1 105-a, such as STAs 115-a, 115-b, 115-d, and 115-e for data transmission over an OFDMA frame. In some aspects, based on a determination by AP1 105-a, STAs 115-a and 115-b may be established as the subset of the STAs.

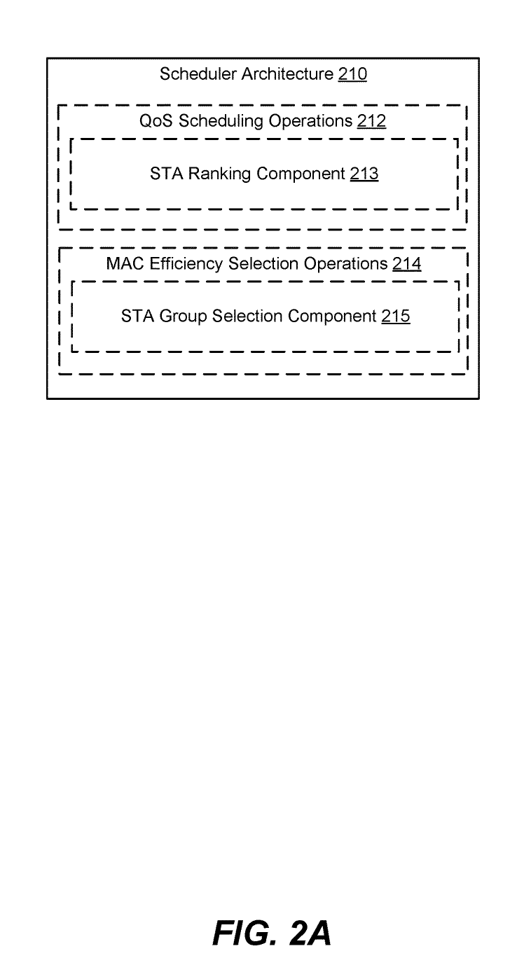

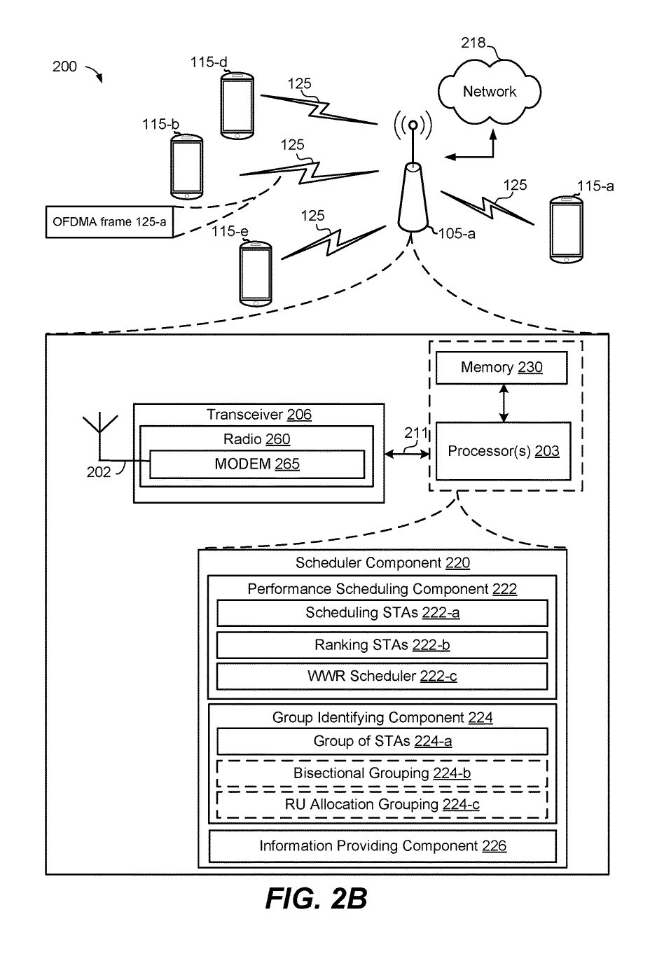

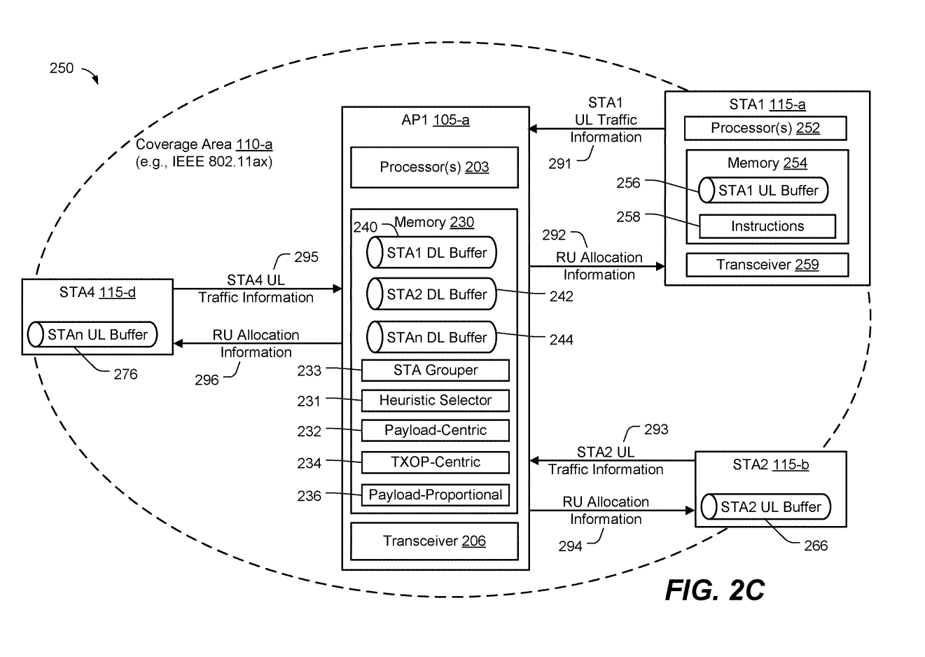

Referring to FIG. 2A, in an aspect, an example of a scheduler architecture 210 with reference to one or more methods and one or more components, such as scheduler component 220 (FIG. 1), that may separately schedule and group multiple users during wireless communications. In an aspect, scheduler architecture 210 may operate in an AP, such as AP1 105-a of FIG. 1. Moreover, scheduler architecture 210 may correspond to either hardware residing in an AP, or software operating in configuration with a memory and processor of an AP in order to perform the procedure for separately scheduling and grouping multiple STAs during wireless communications.

For example, scheduler architecture 210 may include Quality of Service (QoS) scheduling operations 212 and Medium Access Control (MAC) efficiency selection operations 214 for separately scheduling and grouping multiple STAs during wireless communications, such as STAs 115-a, 115-b, 115-d, and 115-e of FIG. 1. That is, QoS scheduling operations 212 may perform scheduling for a number of STAs while MAC efficiency selection operations 214 performs grouping for the number of STAs without depending on rankings of STAs scheduled by QoS scheduling operations 212. In particular, QoS scheduling operations 212 may schedule multiple wireless STAs associated with the AP, the scheduling including ranking each of the multiple STAs based at least in part on performance requirements of the respective STA. In some aspects, QoS scheduling operations 212 may include an STA ranking component 213, which may be configured to map a first scheduling cycle resulting from the ranking of each of the multiple STAs to a second scheduling cycle used by a token-based weighted round robin (WRR) scheduler, the second scheduling cycle being longer than the first scheduling cycle.

Further, MAC efficiency selection operations 214 may identify, separately from the scheduling and based at least in part on the ranking, a group of STAs from the multiple STAs for transmission of data over a single OFDMA frame in spectrum WLAN. In some aspects, MAC efficiency selection operations 214 may include an STA group selection component 215, which may be configured to identify a first subset of the multiple STAs that are higher ranked than a second subset of the multiple STAs in the ranking, and select the group of STAs by adjusting one or more of a number of unused time resources, frequency resources, or a combination thereof, associated with the transmission of data over the single OFDMA frame, a number of STAs in the group of STAs, or a length of a PPDU. In these aspects, identifying the group of STAs comprises selecting the group of STAs by adjusting a length of a PPDU, and adjusting a length of the PPDU includes identifying an upper bound PPDU length, a lower bound PPDU length, and a target PPDU length; and iteratively performing: identifying eligible STAs from the multiple STAs that satisfy an unused resource threshold for the target PPDU length, determining a total number of resource units (RUs) that the eligible STAs occupy, and setting the target PPDU length to be the upper bound PPDU length in response to a determination that the total number of RUs meets a maximum number of RUs, or setting the target PPDU length to be the lower bound PPDU length in response to a determination that the total number of RUs does not meet the maximum number of RUs. In another aspect, STA group selection component 215 may identify the group of STAs comprises selecting the group of STAs by sorting the multiple STAs in accordance to their queue length, selecting the first N sorted STAs as candidate STAs, where N is a maximum number of RUs supported, selecting a PPDU duration from multiple PPDUs durations resulting from an iterative allocation of RUs to different subsets of the candidate STAs, and forming the OFDMA frame based on the selected PPDU duration and corresponding allocation of RUs and subset of candidate STAs. In an aspect, scheduler architecture 210 may be configured to provide information to each of the multiple STAs resulting from the scheduling the multiple STAs and the identifying of the group of STAs.

Referring to FIG. 2B, in an aspect, a wireless communication system 200 includes STAs 115-a, 115-b, 115-d, and 115-e in wireless communication with at least one AP, such as AP1 105-a connected to network 218, similar to STAs 115-a, 115-b, 115-d, and 115-e, and AP1 105-a of FIG. 1. The STAs 115-a, 115-b, 115-d, and 115-e may communicate with network 218 via AP1 105-a. In an example, STAs 115-a, 115-b, 115-d, and 115-e may transmit and/or receive wireless communication to and/or from AP1 105-a via one or more communication link 125 such as one or more OFDMA frames 125-a, which may include an uplink communication channel (or simply uplink channel) and a downlink communication channel (or simply downlink channel), such as but not limited to an uplink data channel and/or downlink data channel. Such wireless communications may include, but are not limited to, data, audio and/or video information. In some instances, such wireless communications may include control or similar information. In an aspect, an AP, such as AP1 105-a may be configured to separately schedule and group a plurality of STAs, such as STAs 115-a, 115-b, 115-d, and 115-e, to maximize network capacity while optimizing data packet delay and throughput. For example, AP1 105-a may perform scheduling and grouping for STAs 115-a, 115-b, 115-d, and 115-e via communications links 125. In another aspect, AP1 105-a may dynamically identify STAs 115-a, 115-b, 115-d, and 115-e, or a subset of these STAs, for a particular grouping of STAs.

In accordance with the present disclosure, AP1 105-a may include a memory 230, one or more processors 203 and a transceiver 206. The memory, one or more processors 203 and the transceiver 206 may communicate internally via a bus 211. In some examples, the memory 230 and the one or more processors 203 may be part of the same hardware component (e.g., may be part of a same board, module, or integrated circuit). Alternatively, the memory 230 and the one or more processors 203 may be separate components that may act in conjunction with one another. In some aspects, the bus 211 may be a communication system that transfers data between multiple components and subcomponents of the AP1 105-a. In some examples, the one or more processors 203 may include any one or combination of modem processor, baseband processor, digital signal processor, and/or transmit processor. Additionally or alternatively, the one or more processors 203 may include a scheduler component 220 for carrying out one or more methods or procedures described herein. The scheduler component 220 may comprise hardware, firmware, and/or software and may be configured to execute code or perform instructions stored in a memory (e.g., a computer-readable storage medium).

In some examples, the AP1 105-a may include the memory 230, such as for storing data used herein and/or local versions of applications or scheduler component 220 and/or one or more of its subcomponents being executed by the one or more processors 203. Memory 230 can include any type of computer-readable medium usable by a computer or processor 203, such as random access memory (RAM), read only memory (ROM), tapes, magnetic discs, optical discs, volatile memory, non-volatile memory, and any combination thereof. In an aspect, for example, memory 230 may be a computer-readable storage medium (e.g., a non-transitory medium) that stores computer-executable code. The computer-executable code may define one or more operations or functions of scheduler component 220 and/or one or more of its subcomponents, and/or data associated therewith. The computer-executable code may define these one or more operations or functions when AP1 105-a is operating processor 203 to execute rate adaptation component 30 and/or one or more of its subcomponents. In some examples, the AP1 105-a may further include a transceiver 206 for transmitting and/or receiving one or more data and control signals to/from an STA, such as 115-a, 115-b, 115-d, and 115-e. The transceiver 206 may comprise hardware, firmware, and/or software and may be configured to execute code or perform instructions stored in a memory (e.g., a computer-readable storage medium). The transceiver 206 may include multiple radios and modems including radio 260 comprising a modem 265. In an aspect, AP1 105-a and transceiver 206 supports MU-MIMO that enables multiple wireless connections such as a wireless local area network (WLAN) or a short distance communication protocol (e.g., Bluetooth radio) with a plurality of STAs, such as STAs 115-a, 115-b, 115-d, and 115-e. The radio 260 may utilize one or more antennas 202 for transmitting signals to and receiving signals from a plurality of STAs, such as STAs 115-a, 115-b, 115-d, and 115-e.

In an aspect, system 200 may include AP1 105-a, and which AP1 105-a may include a scheduler component 220 having a performance scheduling component 222, group identifying component 224, and information providing component 226. In some aspects, scheduler component 220 may be similar to, or the same as, scheduler architecture 210 (FIG. 2A), and separately schedule and group a plurality of multiple users during wireless communications. Further, performance scheduling component 222 may be similar to, or the same as, QoS scheduling operations 212 (FIG. 2A). Moreover, group identifying component 224 may be similar to, or the same as, MAC efficiency selection operations 214 (FIG. 2A). For example, scheduler component 220 may maximize the network capacity as well as serve as a constraint to provide fairness to individual user data packet delay and throughput for STAs 115-a, 115-b, 115-d, and 115-e. In some aspects, each of the STAs 115-a, 115-b, 115-d, and 115-e may have differing traffic loads. For example, STA 115-a may have a first traffic load and STA 115-b may have a second traffic load that is different from the first traffic load. Further, in some aspects, different frequency domain resources associated with the transmission of data over the single OFDMA frame provide the same data rate. As such, the channels corresponding to communication links 125 are considered flat. In other aspects, the transmission of data over the single OFDMA frame comprises transmission of data using a single physical layer convergence procedure (PLCP) protocol data unit (PPDU).

In an aspect, AP1 105-a and scheduler component 220 may include performance scheduling component 222, which may be configured to schedule multiple wireless STAs associated with AP1 105-a. For example, performance scheduling component 222 may schedule STAs 115-a, 115-b, 115-d, and 115-e (e.g., scheduling STAs 222-a), all of which are in communication with AP1 105-a via communication link 125. Further, performance scheduling component 222 may rank each of the multiple STAs (e.g., ranking STAs 222-b) based at least in part on performance requirements of the respective STA. In an example, performance scheduling component 222 may rank each of the multiple STAs based at least in part on respective latency requirements, throughput requirements, or a combination thereof. In some aspects, the performance requirements may correspond to a Quality of Service (QoS) requirements for each of the STAs 115-a, 115-b, 115-d, and 115-e.

Further, performance scheduling component 222 may employ a Weighted Round Robin (WRR) scheduler 222-c to determine the ranking of each of the multiple STAs. In an aspect, the WRR scheduler 222-c may include one or more weights assigned by increasing function of

$$tuple ( \frac{d}{D} , \frac{r}{R} ) ,$$

where d corresponds to the current packet delay, D corresponds to the delay requirement, r corresponds to the user data rate, and R corresponds to the current throughput. In an example, the use of the increasing function as the weight allows for the delay relative to the latency requirement and the throughput relative to the data rate to be taken into account. As such, a WRR scheduler 222-c establishes uniformity with regard to the user packet delay and throughout.

In some aspects, performance scheduling component 222 may be configured to implement the WRR scheduler 222-c using one or more tokens. For example, performance scheduling component 222 may map a first scheduling cycle (e.g., 10 ms) resulting from the ranking of each of the multiple STAs to a second scheduling cycle or super scheduling cycle (e.g., 100 ms) used by a token-based WRR scheduler 222-c, the second scheduling cycle being longer than the first scheduling cycle. In particular, in each scheduling cycle, performance scheduling component 222 may inject one or more tokens to one or more STAs that are proportional to their weights. An STA may accept a token if it is grouped for an OFDMA frame transmission. The STAs with the highest number of tokens may proceed to the group identifying component 224. Once performance scheduling component 222 determines that all backlogged STAs have no more tokens, performance scheduling component 222 may then replenish all STAs with tokens and begin another scheduling cycle. In some aspects, the token mapping may be proportional to a number of resource units assigned to each user of an STA.

In an aspect, AP1 105-a and scheduler component 220 may include group identifying component 224, which may be configured to identify, separately from the scheduling and based at least in part on the ranking, a group of STAs from the multiple STAs for transmission of data over a single OFDMA frame in spectrum WLAN. For example, group identifying component 224 may identify the group of STAs based at least on MAC layer data. In some aspects, group identifying component 224 may identify a first subset of the multiple STAs that are higher ranked than a second subset of the multiple STAs in the ranking, and select the group of STAs from among the first subset.

In another aspect, group identifying component 224 may identify the group of STAs by selecting the group of STAs (e.g., group of STAs 224-a) by adjusting one or more of a number of unused time resources, frequency resources, or a combination thereof, associated with the transmission of data over the single OFDMA frame, a number of STAs in the group of STAs (e.g., group of STAs 224-a), a length of a PPDU. In some instances, padding is utilized, for example, to ensure that a set of encoded (and, if needed, padded) information bits entirely fills out an integer number of OFDM symbols, for example. In an example, group identifying component 224 may perform bisectional grouping 224-b in order to adjust a length of the PPDU. In particular, group identifying component 224 may identify an upper bound PPDU length, a lower bound PPDU length, and a target PPDU length. Once identified, group identifying component may iteratively perform the follow procedure until the length of the PPDU is properly adjusted. First, group identifying component 224 may identify eligible STAs from the multiple STAs (e.g., STAs 115-a, 115-b, 115-d, and 115-e) that satisfy an unused resource threshold for the target PPDU length. For example, in one aspect, eligible STAs may only correspond to a subset of the multiple STAs, such as STAs 115-a and 115-b. Once the eligible STAs are identified, group identifying component may determine a total number of resource units (RUs) that the eligible STAs occupy. After determining the total number of RUs, group identifying component 224 may set the target PPDU length to be the upper bound PPDU length in response to a determination that the total number of RUs meets a maximum number of RUs, or setting the target PPDU length to be the lower bound PPDU length in response to a determination that the total number of RUs does not meet the maximum number of RUs. As such, this process is repeated until the length of the PPDU is properly adjusted.

In another aspect, group identifying component 224 may identify the group of STAs by using proportional RU allocation grouping 224-c. For example, group identifying component 224 may sort the multiple STAs 115-a, 115-b, 115-d, and 115-e in accordance to their queue length. Then, group identifying component 224 may select the first N sorted STAs as candidate STAs, where N is a maximum number of RUs supported. Subsequently, group identifying component 224 may select a PPDU duration from multiple PPDUs durations resulting from an iterative allocation of RUs to different subsets of the candidate STAs. Finally, group identifying component 224 may form the OFDMA frame based on the selected PPDU duration and corresponding allocation of RUs and subset of candidate STAs.

In an aspect, AP1 105-a and scheduler component 220 may include information providing component 226, which may be configured to provide information to each of the multiple STAs resulting from scheduling the multiple STAs and identifying the group of STAs. For example, information providing component 226 may trigger AP1 105-a to transmit, via transceiver 206, the information to the one or more STAs 115-a, 115-b, 115-d, and 115-e. The information may correspond to scheduling information to establish the scheduling for each of the STAs 115-a, 115-b, 115-d, and 115-e. In some aspects, WLANs provide more flexibility than cellular networks with regard to OFDMA frame transmissions since WLANs, such as WIFI provide asynchronous networks as compared to synchronous cellular networks. For example, OFDMA frame transmissions in a WLAN has the ability to adjust frame length in relation to the time domain. If the frame length is adjusted to be larger in length, then the efficiency of the transmissions are improved in relation to loss overhead. However, the increase in frame length results more padding of the frame, and in some instances, STAs may not be configured to use the additional padding thereby causing increased inefficiency. Nonetheless, scheduler component 220 may schedule each of the STAs 115-a, 115-b, 115-d, and 115-e by taking these considerations into account in order to optimize transmissions across the network.

Moreover, in WLANs, an AP, such as AP1 105-a may be configured to authorize one or more STAs to transmit uplink data once the AP captures a channel for transmission. For example, AP1 105-a and scheduler component 220 may schedule multiple STAs, such as STAs 115-a, 115-b, 115-d, and 115-e, by aligning the PPDU lengths of every STA. In an aspect, AP1 105-a and scheduler component 220 may align the PPDU lengths by scheduling the beginning of the start of the PPDU frames at the same time, and selecting only STAs with payloads of the same size or similar sizes. As a result, the lengths of the PPDU frames are the same or similar, and thus, the PPDU frames end at the same or similar time, so AP1 105-a may relinquish the channel. Additionally, when the AP captures a channel for transmission for multiple STAs, each subchannel of the channel is designated to only on STA.

Further, in an aspect, AP1 105-a and scheduler component 220 may schedule multiple STAs, such as STAs 115-a, 115-b, 115-d, and 115-e, by grouping multiple STAs, so that the grouped STAs transmit in a single frame. For example, the grouped STAs may transmit their respective ACK messages in response to transmissions from AP1 105-a in a single transmission frame instead of each STA transmitting their respective ACK message separately. For example, if an AP serves 100 STAs, and groups the STAs in to 10 groups, then AP may schedule transmissions such that each group only sends their ACKs within a single transmission. As such, the AP may receive 10 transmission messages instead of 100, thereby decreasing channel utilization and increasing transmission efficiencies.

Furthermore, an AP, such as AP 105-a (FIGS. 1 and 2B), executing scheduler component 220, may include various heuristics (e.g., algorithms) for selecting a group of STAs and allocating RUs (e.g., OFDMA RUs) to the STAs of the selected group. In particular aspects, the described techniques are applicable for both uplink (UL) and downlink (DL) transmissions. Institute of Electrical and Electronics Engineers (IEEE) 802.11ax, also known as the “High Efficiency WLAN,” is an in-progress industry standard that is expected to use OFDMA for multi-user operation, including in indoor and outdoor scenarios that are impacted by interfering signal sources, dense heterogeneous networks, and heavily loaded access points. Thus, in some examples, the described techniques for separate scheduling and grouping as well as the heuristics for STA group selection and RU allocation may be used in an IEEE 802.11ax wireless network.

Various factors may be considered when selecting STAs for an OFDMA group. For example, the amount of data that is buffered for transmission with respect to each STA may be considered. The amount of data may be indicated by a buffer occupancy of a buffer for the STA (see buffers 240, 242, 244 in FIG. 2C). As another example, the number of STAs to include in the OFDMA group may vary based on quality of service (QoS) requirements associated with the STAs. STAs having a large amount of buffered data may be served in an OFDMA group that provides high data throughput rate. As another example, to provide low access delays, an OFDMA group may include as many STAs as possible.

In some aspects, the data rate for each STA in an OFDMA group may be determined based on channel conditions. To illustrate, in a “flat” channel, all RUs of the same size have the same data rate. Conversely, in a frequency selective channel, different RUs may have different data rates, and therefore a specific RU allocated to a STA may impact the data rate for that STA. Other factors that may be considered include, but are not limited to, the use of padding and time-domain cutting for transmission efficiency, group size and RU size constraints imposed by a networking protocol (e.g., IEEE 802.11ax), and channel quality indications (CQIs) for different RUs.

In accordance with an illustrative aspect, determining the STAs of an OFDMA group may include starting with the assumption that the channel is a flat channel. An ideal RU size may be computed for each STA that has buffered traffic. The ideal RU size corresponds to an RU size for an RU of each STA that when grouped with the other RUs minimizes transmission overhead. Next, the number of STAs in the OFDMA group may be adjusted based on the computed RU sizes and based on a balance of high throughput rate vs. low access delay. The RU sizes for the STAs in the OFDMA group may be mapped to a constrained RU size (e.g., one of the permitted RU sizes in IEEE 802.11ax). If additional RUs are available, additional STAs may be added to the OFDMA group. Once the OFDMA group is determined, RU allocation may be performed to determine which specific RU should be allocated to each of the STAs in the OFDMA group. In some examples, the RU allocation may be performed using one of multiple heuristics described herein.

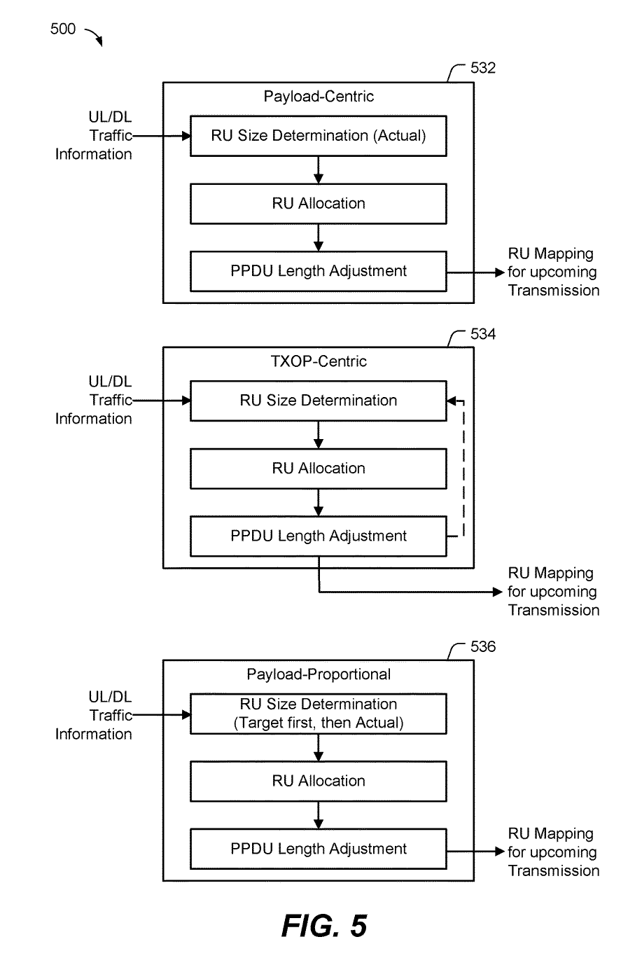

To illustrate, in a first aspect, a payload-centric heuristic is described for RU allocation details of the description are provided below in connection with at least FIGS. 2C and 5. In a second aspect, a transmit opportunity (TXOP)-centric heuristic is described for RU allocation. In a third aspect, a payload-proportional heuristic is described for RU allocation. Different heuristics may provide a different balance of frequency domain and/or time domain media access control (MAC) layer efficiency, fairness, and a reduction in channel access delay. In an illustrative example, channel access delay corresponds to an amount of time between when a payload reaches the front of a queue or buffer to when the payload is served (e.g., transmitted).

The payload-centric heuristic may prioritize MAC efficiency and overall throughput, and may therefore be used when many STAs have high buffer occupancy of traffic that has not been served. For UL transmissions, the buffers may be located at individual STAs. For DL transmissions, the buffers may be located at an access point (AP). The TXOP-centric heuristic may prioritize per-STA fairness and channel access delay, and may therefore be used when urgent or high-priority data is buffered. The payload-proportional heuristic may strike a balance between MAC efficiency and channel access delay. Thus, the payload-proportional heuristic/algorithm may be selected as a default algorithm for both UL and DL unless many STAs have high buffer occupancy or when STAs have urgent or high-priority traffic.

In particular aspects, each of the described heuristics includes three stages of operation: RU size determination, RU allocation, and PPDU length adjustment. Illustrative examples of each of the stages of each of the heuristics are further described herein. In some aspects, a padding stage may be performed, in which payloads are padded (e.g., zero-padded) so that an equal number of bits is transmitted to, or from, each STA.

In some examples, the channel being used for wireless communication may be frequency selective rather than flat. OFDM grouping for a frequency selective channel may include starting from a flat channel scenario by assuming that a mean signal-to-noise ratio (SNR) of a frequency selective channel is the theoretical SNR if the channel were a flat channel. The SNR for each RU to be allocated may be computed based on the RU sizes determined for candidate STAs, as described above. STAs may be prioritized based on their computed RU sizes, and RU allocation may be performed to maximize the throughput for each STA (e.g., using the payload-proportional or payload-centric heuristics described above).

Referring to FIG. 2C, a particular illustrative aspect of a system 250 operable to allocate RUs is shown. The system 250 includes a plurality of devices configured to communicate via a coverage area 110-a. In FIG. 2C, the system 250 includes four devices: an access point, such as AP1 105-a, and three STAs (STAs) 115-a (designated “STA1”), 115-b (designated “STA2”), and 115-d (designated “STA4,” where n is an integer greater than or equal to 3). AP1 105-a corresponds to AP1 105-a of at least FIGS. 1 and 2B, and includes scheduler component 220. It is to be understood that in alternative aspects, the system 250 may include a different number of electronic devices, access points, and/or STAs.

Similar to FIG. 2B, AP1 105-a of FIG. 2C may include one or more processors 203, a memory 230, and at least one transceiver 206 configured to communicate via the coverage area 110-a, and perform similar operations as described above with reference to FIG. 2B. Although a transceiver 206 is shown, in alternative aspects separate transmitter(s) and receiver(s) may be included. If the AP1 105-a is an access point, the memory 230 may store one or more buffers that buffer DL data that is to be transmitted to the STAs 115-a, 115-b, 115-d. To illustrate, a first DL buffer 240 may store data that is awaiting transmission (e.g., via the transceiver 206) to the first STA 115-a. A second DL buffer 242 may store data that is awaiting transmission to the second STA 115-b. A third DL buffer 244 may store data that is awaiting transmission to the third STA 115-d.

Each of the STAs 115-a, 115-b, 115-d may also include processor(s) and memory. In a particular aspect, as shown in FIG. 2C, a memory 254 at the STA 115-a may include a first UL buffer 256 configured to store UL data awaiting transmission (e.g., via a transceiver 259) to the AP1 105-a. The second STA 115-b and the third STA 115-d may also include UL buffers 266 and 276, respectively, configured to store data awaiting transmission to the AP1 105-a.

The buffers 240, 242, 244, 256, 266, and 276, and data stored therein, may have various associated characteristics that may be used to determine when and how to communicate the data. For example, buffers shown in FIG. 2C may have an associated buffer occupancy, representing how “full” or how “empty” the buffer is. Buffer occupancy may be represented in terms of data size (e.g., in bytes, megabytes, etc.), in terms of number of data blocks or messages, or in terms of some other unit. Different data may also have different latency performance that can affect when and how to transmit the data. For example, certain network status/management messages, live voice or video streaming data, etc. may be classified as low latency or urgent. Conversely, asynchronous file download data may be classified as non-urgent (e.g., medium or high latency). Although FIG. 2C illustrates an example in which an access point can store per-STA DL buffers and in which each STA can store an UL buffer, it is to be understood that in alternative aspects, DL and/or UL data may be buffered differently.

In an illustrative aspect, the coverage area 110-a supports OFDMA communication. For example, the coverage area 110-a may operate and support communication in accordance with an IEEE 802.11ax wireless networking protocol or specification. The use of OFDMA may enable multiple devices to, simultaneously or at least partially simultaneously, communicate data in multiple directions. In accordance with OFDMA principles, an OFDMA group may be determined for a transmission, where the OFDMA group includes the devices that will be authorized to transmit UL data or will be receiving DL data during the transmission. To mitigate interference, each of the devices of the OFDMA group may be assigned a specific set of frequencies on which to communicate. To illustrate, the AP1 105-a may be configured to send a DL OFDMA transmission in which different groups of frequency subcarriers (RUs) carry data directed to different ones of the STAs 115-a, 115-b, and/or 115-d. As another example, the AP1 105-a may be configured to receive an UL OFDMA transmission in which different groups of frequency subcarriers (also called RUs) carry data transmitted by different ones of the STAs 115-a, 115-b, and/or 115-d. In some examples, one or more devices in the system 250 are capable of operating as an access point or a STA. Thus, depending on configuration, any of the devices in the system 250 may be capable of transmitting and/or receiving an UL and/or DL OFDMA transmission, or portion thereof.

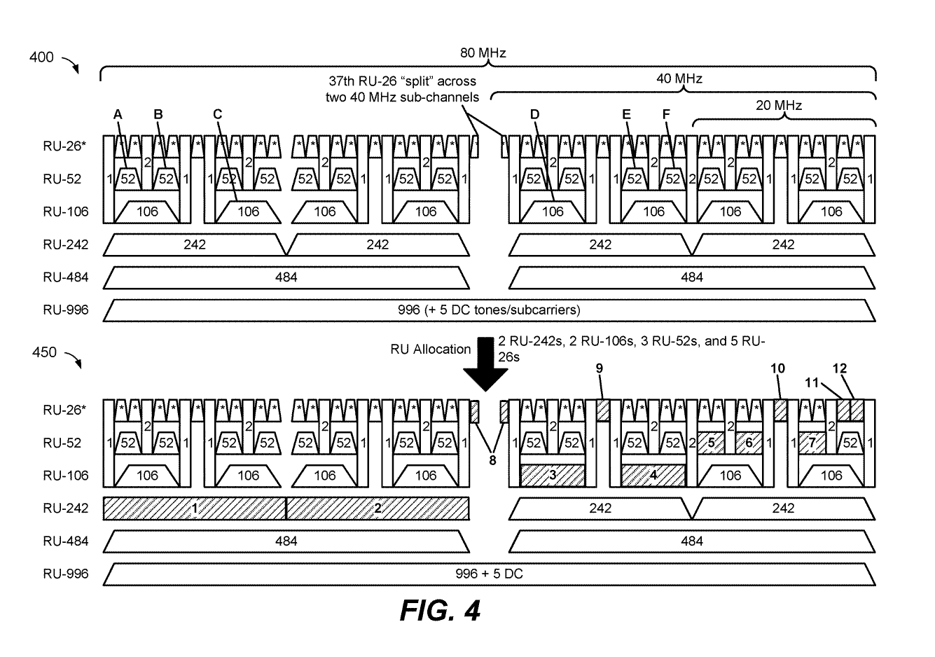

Although the use of OFDMA may increase throughput by enabling simultaneous communication to/from multiple devices, determining the devices to be included in an OFDMA group and determining per-device RU allocations for the devices in the OFDMA group can be a computationally complex problem due to the need to satisfy various requirements. For example, FIG. 4 depicts an illustrative arrangement 400 of frequency subcarriers. Left-to-right in FIG. 4 corresponds to the frequency domain. As shown in FIG. 4, there may be a finite number of available RU sizes. In particular, FIG. 4 illustrates RU sizes limited to the following finite list of sizes: 26 subcarriers, 52 subcarriers, 106 subcarriers, 242 subcarriers, 484 subcarriers, or 996 subcarriers.

A 20 megahertz (MHz) wireless channel may accommodate up to one RU-242 (i.e., an RU of 242 subcarriers), two RU-106s, four RU-52s, or 9 RU-26s, as shown. A 40 MHz wireless channel may accommodate up to one RU-484, two RU-242s, four RU-106s, eight RU-52s, or eighteen RU-26s. An 80 MHz wireless channel may accommodate up to one RR-996, two RU 484s, four RU-242s, eight RU-106s, sixteen RU-52s, or thirty-seven RU-26s (the thirty-seventh RU-26 being “split” across the two 40 MHz sub-channels, as shown).

RUs may also be restricted in terms of where they can be placed in the frequency domain. That is, RUs may be located, positioned, or assigned to specific places in the frequency domain. To illustrate, for ease of explanation, the different RU sizes are shown in a vertical stack. If one RU-106 and two RU-52s are to be allocated in a 20 MHz channel, the RU-106 can follow the RU-52s in the frequency domain (as shown by the RUs denoted “A,” “B,” and “C” in FIG. 4). Alternatively, the RU-106 can precede the RU-52s in the frequency domain (as shown by the RUs denoted “D,” “E,” and “F” in FIG. 4). However, the RU-106 may not be located between the RU-52s in the frequency domain.

FIG. 4 thus illustrates that one requirement that can impact OFDMA grouping and RU allocation is the requirement that each allocated RU fit into the size/location requirements of a wireless networking protocol or specification (e.g., IEEE 802.11ax).

Returning to FIG. 2C, the AP1 105-a and the STAs 115-a, 115-b, 115-d may be configured to determine OFDMA groups and RU allocations for OFDMA transmissions. For example, the memory 230 may store instructions executable by the processor(s) to perform various operations described herein, including but not limited to grouping and RU allocation operations. To illustrate, the memory 230 may store a STA grouper 233 a heuristic selector 231 that are executable to select one of a plurality of available heuristics to be used to determine when and how data is to be communicated via the coverage area 110-a. In the example of FIG. 2C, the heuristics available for selection include a payload-centric heuristic 232, a TXOP-centric heuristic 234, and a payload-proportional heuristic 236, each of which is further described herein. The STAs 115-a, 115-b, 115-d may also store such instructions executable by processor(s). For example, the memory 254 at the first STA 115-a may store instructions 258 executable by processor(s) 252 to perform RU allocation as described herein.

In an illustrative aspect of DL operation, the AP1 105-a may determine information that is used to select a RU allocation heuristic. In particular aspects, the RU allocation heuristic may be selected after the STA grouper 233 determines an OFDMA group for a DL transmission, as further described herein with respect to operation of the STA grouper for an upcoming UL transmission. The heuristic selector 231 may determine the buffer occupancies of the DL buffers 240-244 and/or latency performance associated with the STAs 115-a, 115-b, 115-d. As used herein, the latency performance associated with a STA may indicate whether urgent/high-priority data is buffered at or for the STA, access delay associated with the STA (e.g., how many TXOPs have occurred without the STA being served), whether a STA is underserved or overserved in view of the STA's buffered data being urgent/high-priority or non-urgent/low-priority, etc. Based on the buffer occupancies, the latency performance, or both, the heuristic selector 231 may select the payload-centric heuristic 232, the TXOP-centric heuristic 234, or the payload-proportional heuristic 236 for use in determining RU allocations.

In a particular aspect, the payload-centric heuristic 232 may be focused on improving MAC efficiency, and may thus be selected when a large amount of unserved data is buffered in one or more of the DL buffers 240-244. To illustrate, the payload-centric heuristic 232 may be selected when a threshold number or percentage (e.g., 50%) of the buffers 240-244 have buffer occupancies that exceed a buffer occupancy threshold (e.g., 60% buffer occupancy). In a particular aspect, the TXOP-centric heuristic 234 may be focused on per-STA fairness and reducing channel access delay, and may thus be selected when a threshold number or percentage (e.g., 40%) of the buffers 240-244 have low-latency or urgent data that (or if at least a threshold amount of low-latency or urgent data is) is awaiting transmission. In some aspects, the data buffered for a STA may be considered to be “urgent” (or the STA itself may be considered to be “urgent”) if the data (or STA) has not been served in a long time, such as for at least a threshold number of TXOPs. In a particular aspect, the payload-proportional heuristic 236 balances between MAC efficiency and channel access delay, and may thus be a default heuristic that is selected unless one of the above-described conditions results in selection of the payload-centric heuristic 232 or the TXOP-centric heuristic 234.

After a heuristic is selected for the upcoming DL transmission, the heuristic may be used to allocate RUs of the upcoming DL transmission to one or more of the STAs 115-a, 115-b, 115-d, as further described with reference to FIGS. 4-6, 11 and 12. In a particular aspect, the AP1 105-a may transmit RU allocation information to one or more of the STAs 115-a. 115-b, 115-d. The RU allocation information notifies each STA of the RU(s) allocated to that STA.

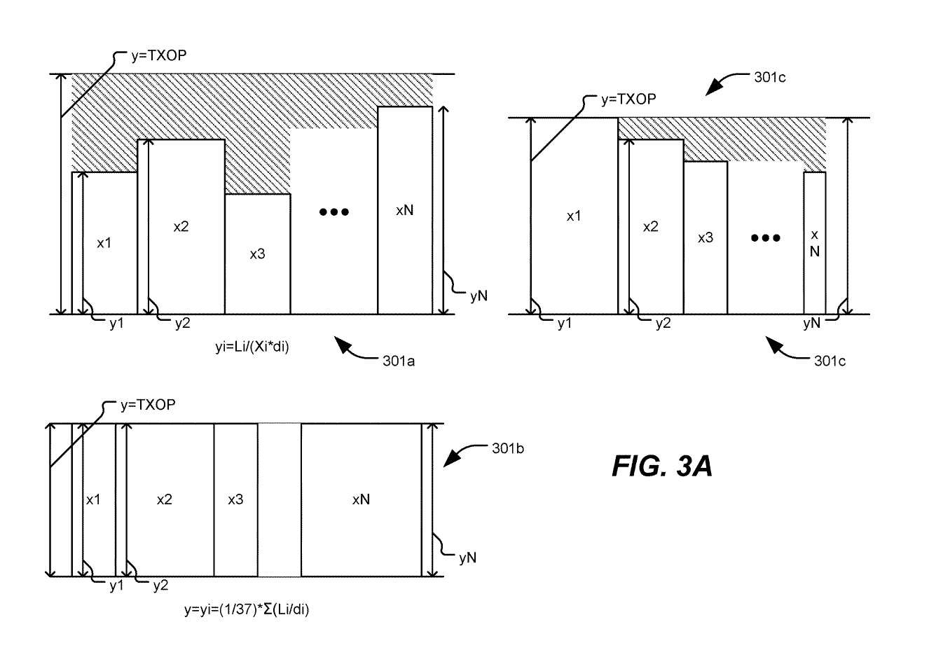

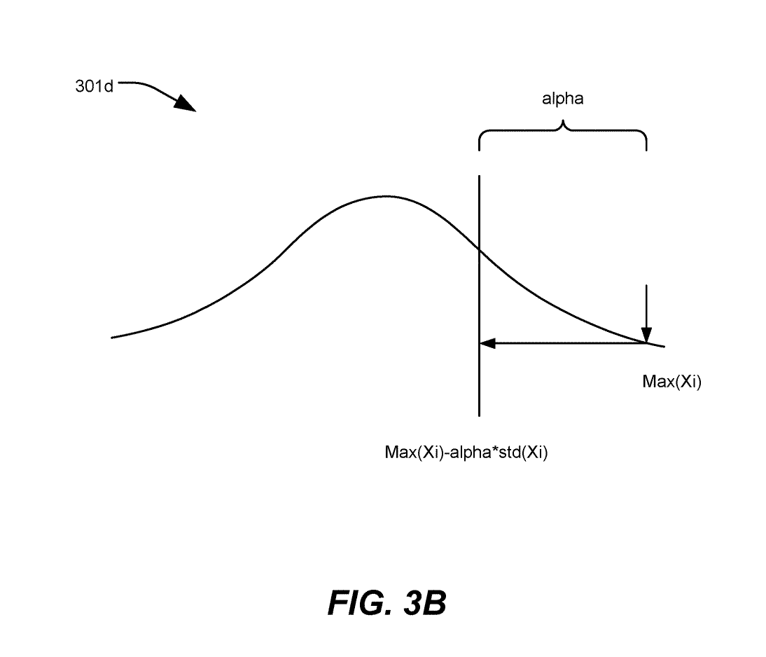

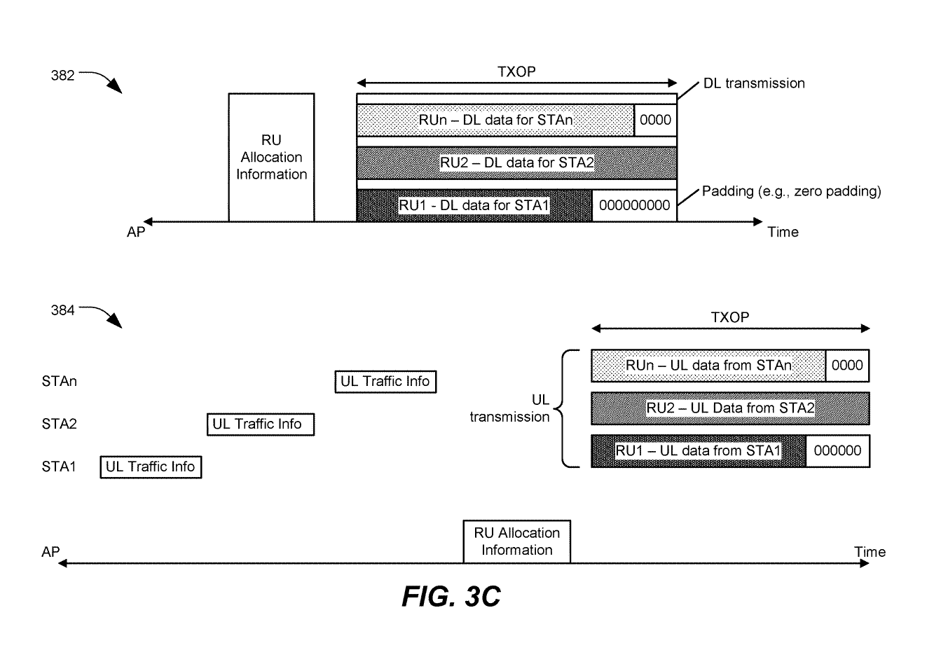

For example, the AP1 105-a may transmit first RU allocation information 292 to the first STA 115-a, second RU allocation information 294 to the second STA 115-b, and third RU allocation information 296 to the third STA 115-d. RU allocation information may be transmitted as part of a message payload, a message header, a trigger frame, or in some other fashion. In an illustrative aspect, RU allocation information is included in a signal field, such as a high-efficiency signal B (HE-SIG-B) field, of a message. During a subsequent (e.g., next) TXOP, the AP1 105-a may construct and send an OFDMA transmission that includes data retrieved from the buffers 240-244. Each of the STAs 115-a, 115-b, 115-d may receive and decode their respective DL data from the OFDMA transmission based on their assigned RU. For example, as shown in a timing diagram 382 in FIG. 3C, for DL communication, the AP1 105-a (e.g., an AP) may transmit RU allocation information followed by a DL transmission during a subsequent TXOP. The DL transmission may include DL data for multiple STAs on their respective allocated RUs, as shown.

In an illustrative aspect of UL operation, one or more of the STAs 115-a, 115-b, 115-d may send UL traffic information to the AP1 105-a. For example, the first STA 115-a may send first UL traffic information 291 to the AP1 105-a, the second STA 115-b may send second UL traffic information 293 to the AP1 105-a, and the third STA 115-d may send third UL traffic information 295 to the AP1 105-a. The UL traffic information 291, 293, and 295 may indicate whether and/or how much UL traffic for the AP1 105-a is buffered at the buffers 256, 266, and 276, respectively. The UL traffic information 291, 293, and 295 may also indicate latency performance information (e.g., whether any of the buffered data is low-latency or urgent).

In a particular aspect, the STA grouper 233 may determine an OFDMA group for the upcoming UL transmission. It is to be understood that various operations described herein as being performed to determine an UL OFDMA group may alternatively be used to determine a DL OFDM group. Determining the OFDMA group may include determining RU sizing for the OFDMA group so as to maximize time domain and frequency domain MAC efficiency, which is indicated in the diagram shown at 301a in FIG. 3A using hatching. To illustrate, assume that an 80 MHz channel is available for use to communicate during an upcoming UL TXOP. To achieve high throughput, RU sizing may be determined based on the solution to Equation 1, subject to Constraint 1 and Constraint 2:

$$\begin{matrix}Min \sum ( ( y - yi ) * Xi ) = min \sum ( ( y - \frac{Li}{Xi * di} ) * Xi ) & Equation 1 \\ \sum Xi = 37 & Constraint 1 \\ y \geq \frac{Li}{Xi * di} & Constraint 2\end{matrix}$$

where Li is the amount of data buffered for STA i (e.g., the buffer occupancy of the UL buffer for STA i), di is the data rate for STA i, Xi is the “ideal” RU size for STA i, and yi is the transmission duration for STA i.

If the channel is assumed to be a flat channel (rather than a frequency selective channel), di is constant at different RU locations. It is noted that Constraint 1 limits the sum of RU sizes is 37. As explained above, in an 80 MHz IEEE 802.11ax channel, up to 37 STAs may be accommodated, where each STA is allocated a minimum size RU-26. Thus, Xi=1 represents 26 subcarriers, or roughly 1/37th of the available channel in the frequency domain. Equation 2 results by solving Equation 1 for Xi using Lagrangian methods:

$$Xi = \frac{Li}{di} \frac{37}{\sum Li / di} \qquad Equation 2$$

The value of Xi according to Equation 2 may represent the value that minimizes padding that will be applied to “fill in” STA transmissions in the time domain, as shown at 301b in FIG. 3A (where hatching is reduced/minimal). In this case, Xi is proportional to Li and inversely proportional to di, which may provide high throughput but may result in long channel access delays for STAs having smaller payloads. For example, when there are more than 37 STAs having buffered payloads, some of the STAs having the smallest payloads may be excluded from one or more UL TXOPs while STAs having larger payloads are served. To provide more transmission opportunities to STAs having smaller payloads, RU sizing may be determined based on Equation 3 instead of Equation 1 (subject to Constraint 1 above):

$$Min \sum ( \frac{( y - yi ) * Xi}{Xi} ) = min \sum ( y - \frac{Li}{Xi * di} ) \qquad Equation 3$$

Equation 4 results by solving Equation 3 for Xi using Lagrangian methods:

$$Xi = \sqrt{Li / di} \frac{37}{\sum \sqrt{Li / di}} \qquad Equation 4$$

The value of Xi according to Equation 4 is proportional to the square root of Li/di (i.e., proportional to the square root of Li and inversely proportional to the square root of di, as Li and di are both positive). In this case, the “ideal” RU size for STAs having large payloads may be controlled, leaving more RU allocation opportunities for STAs having smaller payloads, as shown at 301c in FIG. 3A. To illustrate, the amount of hatching (i.e., unused TXOP) at 301c may be larger than shown at 301b but smaller than shown at 301a.

Direct mapping of the determined RU sizes (e.g., the Xi values determined, for example, based on Equation 4 above) to RUs may be used to generate RU sizes for the STAs of the OFDMA group. However, such a mapping may not be advantageous from a throughput perspective, for example if Li varies greatly amongst the STAs of the OFDMA group. To balance between total throughput rate and access delays, a grouping parameter may be determined based on a distribution 301d (in FIG. 3B) of the computed Xi values. In FIG. 3B and in the following description, “std(Xi)” refers to the standard deviation of Xi, and the grouping parameter is referred to as “alpha.” In an alternative example, a distribution of buffer occupancies may be used instead of a distribution of Xi values. The value of alpha indicates STAs having the highest payloads, and the Lagrangian methods described above may be re-applied to those STAs to identify the RU sizes for those STAs. After those RU sizes are determined, additional STAs (having smaller payloads) may be added to the OFDMA group and be allocated one RU each.

In some aspects, a service flag may be maintained for each STA. The service flag for a STA may be an integer value that is incremented each time the STA is left out of a TXOP. When a STA is included in a TXOP, the service flag may be reset (e.g., to zero). If the value of a STA's service flag exceeds a service flag threshold, the STA may be upgraded for service in the next TXOP. Thus, a higher value of the service flag threshold may mean that users having smaller payloads will wait a longer time before they are upgraded for service (and will thus have less impact on throughput rate by virtue of being upgraded).

A smaller value of alpha may lead to higher throughput and higher access delays, whereas a larger value of alpha may reduce access delays while reducing overall throughput. In some examples, alpha is kept constant to maintain a balance of throughput and access delay. In other examples, alpha is a dynamically tunable parameter for OFDMA grouping. For example, an access delay profile for each STA (or the service flag for each STA) may indicate how long it has been since the STA was last served. When considered in aggregate, the access delay profiles (or service flags) may indicate whether there are a large number of STAs awaiting service. The access delay profiles (or service flags) may thus be used to dynamically adjust alpha to balance high throughput vs. low access delay. To illustrate, when many STAs have experienced a long wait time, the value of alpha may be increased. When overall waiting time is low, the value of alpha may be decreased to achieve higher throughput rates.

Whereas the foregoing description of OFDMA grouping assumes a flat channel, the channel being used for wireless communication may alternatively be frequency selective rather than flat, and in this case different RUs may provide different data rates. OFDM grouping for a frequency selective channel may include determining data rates (di) based on an assumption that a mean signal-to-noise ratio (SNR) of the frequency selective channel is the theoretical SNR if the channel were flat. The RU size for each STA may be determined as in the flat channel case described above with reference to Equation 2 or Equation 4. During RU allocation, STAs may be prioritized based on their computed RU sizes, and RU allocation may be performed to maximize the throughput for each STA in view of differing data rates, di, for different RUs on the frequency selective channel. Due to the differing data rates for different RUs, the transmission time for the STAs may differ. Updated transmissions time may be determined prior to cutting and padding. In some examples, an access point may include a rate adaptation module configured to determine the data rates (di) based on communications with STAs. Data rates may increase or decrease depending on channel conditions, whether STAs move further away from or closer to an access point, etc.

Returning to FIG. 2C, in an example in which each of the STAs 115-a, 115-b, and 115-d is included in the OFDMA group, a heuristic may be used to perform RU allocations for the STAs. For example, based on buffer occupancy and/or latency performance, the heuristic selector 231 may select a heuristic for use in determining RU allocations for the upcoming UL transmission. In a particular aspect, the heuristic selector 231 may select a heuristic as described above with respect to DL operation. For example, the payload-centric heuristic 132 may be selected when a large amount of unserved data is buffered in one or more of the UL buffers 256, 266, 276. The TXOP-centric heuristic 234 may be selected when at least a certain amount of low-latency or urgent data is awaiting transmission. The payload-proportional heuristic 236 may be selected by default if the aforementioned conditions do not apply.

After a heuristic is selected for the upcoming UL transmission, the AP1 105-a may transmit RU allocation information 292, 294, 296 to the STAs 115-a, 115-b, 115-d, respectively, to notify the STAs 115-a, 115-b, 115-d of RU(s) that have been allocated to each of the STAs 115-a, 115-b, 115-d. The RU allocation information 292, 294, 296 may also include PPDU length information. During a subsequent (e.g., next) TXOP, each of the STAs 115-a, 115-b, 115-d may send UL data retrieved from the buffers 256, 266, 276, respectively. The AP1 105-a may receive and decode the UL data from the each of the STAs 115-a, 115-b, 115-d based on the RU allocated to the STAs 115-a, 115-b, 115-d. For example, as shown in a timing diagram 384 in FIG. 3C, for UL communication, the AP1 105-a (e.g., an AP) may receive UL traffic information from multiple STAs and then transmit RU allocation information to the STAs. During a subsequent TXOP, each of the STAs may send UL data to the AP1 105-a on their respective allocated RUs, as shown.

The system 250 of FIG. 2C may thus enable selection of different heuristics for RU allocation, on a per-transmission basis, for both UL and DL data based on “current” network conditions. Because different heuristics may achieve different balances of time/frequency domain MAC efficiency, channel access delay, and per-STA fairness, the dynamic heuristic selection provided by the system 250 may improve data communications in the coverage area 110-a.

Referring to FIG. 5, particular illustrative aspects of the RU allocation heuristics 532-536 are shown. In some examples, each of the heuristics 532-536 may include three stages for UL or DL operation: a RU size determination stage (I), a RU allocation stage (II), and a PPDU length adjustment stage (III). Alternatively, one or more of the stages described below may be replaced or may be supplemented due to operations that may already have been performed during OFDMA grouping, as described above with reference to FIG. 2C.

In an aspect, AP1 105-a may configure heuristic selector 231 to select a payload-centric heuristic 532. In the payload-centric heuristic 532, RU allocation may be performed on a STA-by-STA (or buffer-by-buffer) basis, based on a decreasing order of an amount of buffered data associated with each STA. For example, starting from the STA having the largest buffered payload, an RU size for the STA may be determined as the minimum RU size to serve the STA's payload within a particular duration of time (e.g., within a duration of time corresponding to an upcoming TXOP). To illustrate, when RU sizes are limited to 26, 52, 106, 242, 484, or 996 subcarriers as in the example of FIG. 4, the RU size for a STA needing 28 subcarriers' worth of spectrum may be determined as RU-52. This process may repeated to identify RU sizes for the remaining STAs while the sum of all allocated RU sizes remains under the total RU size available in the wireless channel. If the sum of all RU sizes exceeds the total RU size available in the wireless channel, then STA(s) having the least amount of buffered data may be allocated less than their required number of subcarriers (e.g., only a portion of their buffered payload will be included in the upcoming transmission) or may not be allocated an RU at all.

After RU sizes are determined, the RU allocation stage (II) may be performed iteratively in decreasing order of RU size. For example, the bottom of FIG. 4 illustrates an example 250 of how two RU-242s, two RU-106s, three RU-52s, and five RU-26s may be allocated by iterating in decreasing order of RU size while performing frequency sweeps (i.e., moving left-to-right across the channel in FIG. 4). Thus, in the example at the bottom of FIG. 4, RU size calculation may be visualized as determining the width of the various rectangles, and RU allocation can be visualized as determining where to “place” the rectangles in the frequency band of the wireless channel.

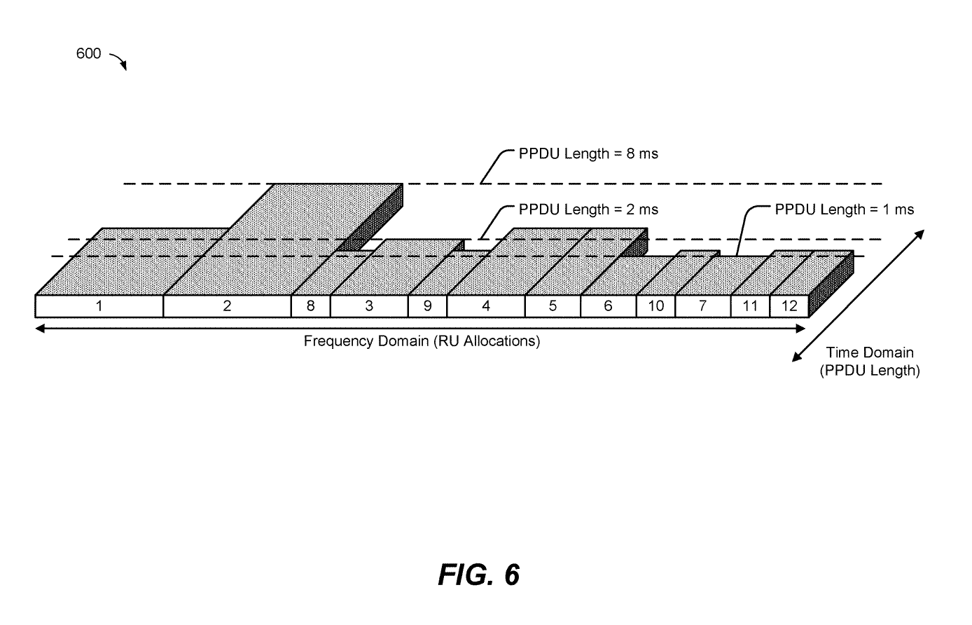

It is noted that the bottom of FIG. 4 illustrates a packed transmission in terms of frequency domain efficiency (e.g., the transmission has zero or few unallocated subcarriers). In particular aspects, the heuristics 532-536 may consider time domain efficiency in addition to frequency domain efficiency. Depending on respective payload sizes and allocated RU sizes, different STAs may need different durations of time to transmit their uplink payloads. Alternatively, different durations of time may needed by an access point to transmit different downlink payloads to different STAs. For example, referring to FIG. 6, for the STA allocated RU “2”, a PPDU length of 8 milliseconds (ms) may be needed for transmission of the STA's uplink or downlink payload. For the STA allocated RU “7,” a PPDU length of 1 ms may be needed to transmit the STA's uplink or downlink payload.

During the PPDU length adjustment stage (III) of the payload-centric heuristic 532, a length of a PPDU corresponding to the upcoming transmission may be determined in a manner that increases time domain efficiency. To illustrate, in the example of FIG. 6, if the PPDU length of the upcoming transmission were set at 8 ms, then the subcarriers of RU “7” will be idle for 7 of the 8 ms because 1 ms is needed to transmit that STA's uplink or downlink payload. Conversely, if the PPDU length were 1 ms, then the transmission would be “packed” in the time domain but ⅞ths of the buffered payload corresponding to RU “2” would be unserved. In this situation, a PPDU length between 1 ms and 8 ms may be selected. In some examples, the PPDU length may be selected so that each allocated RU is idle for less than a threshold amount or percentage of time. To illustrate, in the example of FIG. 6, a PPDU length of 2 ms may be selected.

PPDU length adjustment may thus be considered a cutting operation in the time domain. In some examples, the cutting may be performed so as to maximize MAC efficiency in view of time-domain overhead that is involved in uplink or downlink communications (e.g., block acknowledgement interval, frame spacing intervals, etc.). In particular aspects, a padding operation may be performed for STAs having smaller payloads, as shown in FIG. 1D, so that the number of bits transmitted by each STA during the TXOP is the same.

In the TXOP-centric heuristic 534, the RU size determination stage (I) may include assigning a smallest available RU to each STA having buffered traffic. To illustrate, the smallest available RU may be an RU-26, as described with reference to FIG. 4. Next, the RU allocation stage (II) may “place” the (smallest available) RUs in the wireless channel as described with reference to FIG. 4 and the PPDU length adjustment stage (III) may be performed to achieve time domain efficiency as described with reference to FIG. 6. It will be appreciated that at this point, it is confirmed that at least a transmission with all minimum-sized RU allocations will serve all STAs having buffered traffic (up to a maximum number of STAs that can be accommodated by a single transmission).

However, it will also be appreciated that when there are fewer STAs to serve, allocating minimum-sized RUs to all of the STAs may result in unused frequency subcarriers. To improve frequency domain efficiency, the stages of the TXOP-centric heuristic may be performed iteratively to increment the allocated RU sizes on a per-STA basis. For example, in a second iteration, the STA needing the longest transmission duration to service its payload at the first RU size (e.g., RU-26) may be identified, and that STA's RU size may be incremented (e.g., from RU-26 to RU-52, thereby cutting the required transmission duration for that STA half). However, if it is determined during the RU allocation stage (II) that this RU size increase results in the transmission no longer being able to serve all STAs, then the RU size increase may be reversed to preserve per-STA fairness. If all STAs can still be served despite the size increase for one of the STAs, then another iteration may be performed to attempt a RU size increase for another STA. After the RU size for all STAs has been incremented once, subsequent iterations may be performed to attempt to increment RU sizes on a STA-by-STA basis once again (e.g., from RU-52 to RU-104).

For example, iterations may proceed as follows when there is buffered traffic for 35 STAs (denoted STA1-STA35):
Iteration 1: STA1-STA35 each allocated RU-26. RU allocation and PPDU length adjustment stages are completed and verify that the transmission is possible and accommodates all 35 STAs.
Iteration 2: STA1 allocated RU-52; STA2-STA35 allocated RU-26. RU allocation and PPDU length adjustment stages are completed and verify that the transmission is possible and accommodates all 35 STAs.
Iteration 3: STA1-STA2 allocated RU-52; STA3-STA35 allocated RU-26. RU allocation and PPDU length adjustment stages are completed and verify that the transmission is possible and accommodates all 35 STAs.
Iteration 4: STA1-STA3 allocated RU-52; STA4-STA35 allocated RU-26. However, during all RU allocation stage (II), all 35 STAs cannot be accommodated (32 STAs need a RU-26, but when there are three RU-52s there are only 31 RU-26s available). Therefore, revert STA3 back to a RU-26, and final RU sizes, final RU allocations, and final PPDU length is what was determined in Iteration 3.

In an alternative implementation, if the maximum number of available RUs of each size is known beforehand, only the RU size determination stage (I) may iterate rather than all three stages of the TXOP-centric heuristic 534 iterating.

In the payload-proportional heuristic 536, the RU allocation stage (II) and the PPDU length adjustment stage (III) may operate as described above with respect to the payload-centric heuristic 532. However, the RU size determination stage (I) may operate differently. In the payload-proportional heuristic, a target RU size (rather than an actual RU size) may be determined for a STA as the minimum RU size needed to serve the STA's payload within a particular duration of time. The actual RU for the STA may then be determined such that the actual RU size is integer proportional to a ratio of the target RU size for the STA and a sum of all target RU sizes for all STAs. Stated another way, if the sum of all of the target RU sizes is larger than the available bandwidth, then the payload-proportional heuristic 136 may “squeeze” each STA's RU allocation proportionally, whereas the payload-centric heuristic 532 may maximize RUs for some STAs even if it means other STAs will not be accommodated in the upcoming transmission.

In an aspect, the payload-proportional heuristic 536 is configured to achieve maximum MAC efficiency, reduced scheduling latency, and providing air time-frequency fairness by grouping the STAs in an OFDMA PPDU transmission and assigning RUs to the STAs. For example, the payload-proportional heuristic 536 is configured to find the target RU sizes of the highest weighted STAs (e.g., the highest 8 STAs). Then, the payload-proportional heuristic 536 is configured to calculate the proportionally adjusted target RU size based on Equation 5:

Proportional RU Size=BW*Target RU Size/SUM of All Target RU Sizes Equation 5

Further, the payload-proportional heuristic 536 is configured to find the actual RU size due to quantization based on determining the standard RU size that is larger than the proportional RU size. The payload-proportional heuristic 536 is then configured to allocate RUs by sorting RU sizes from large to small and then allocating the sorted RU sizes one-by-one on the RU size table. The payload-proportional heuristic 536 is then configured to cut the PSDU length in time by finding the efficiency of the current RU allocation in time-frequency as a percentage number, and adjusting the PSDU length in time to the efficiency percentage number of the max PSDU length.

In an aspect, when the number of STAs in the system can be grouped into one PPDU transmission, QoS weights do not have an effect on the air time-frequency resource distribution. The payload-proportional heuristic 536 is configured to cap the RU size for each STA by an upper limit that is proportional to each STA's QoS weight based on Equation 6:

RU Size Cap=BW*QoS Weight/Sum of All QoS Weights Equation 6

In an example, if the target RU size of a STA is less than its RU size cap, the actual RU size is set to target RU size, otherwise, the target RU size of a STA is set to its RU size cap. Since STAs that need less than its RU size cap can free additional RU resources, the RU size calculation iterates on every time any STAs free additional RU resources.

FIGS. 2C, 3A-3C, and 4-6 thus illustrate various examples of RU allocation for STAs in an OFDMA group, including determining the RU size for each STA and determining which specific RU of that size to allocate to each STA In some examples, the number of STAs in the OFDMA group and a RU size cap for the STAs in the OFDMA group may be dynamically adjusted, such as based on alpha, service flags, and/or access delay profiles, after which all or a portion of one of the described heuristics may be applied to allocate RUs to the STAs of the OFDMA group. In other examples, the number of STAs may be fixed (e.g., 37 STAs in the case of an 80 MHz case) and all or a portion of one of the described heuristics may be applied.

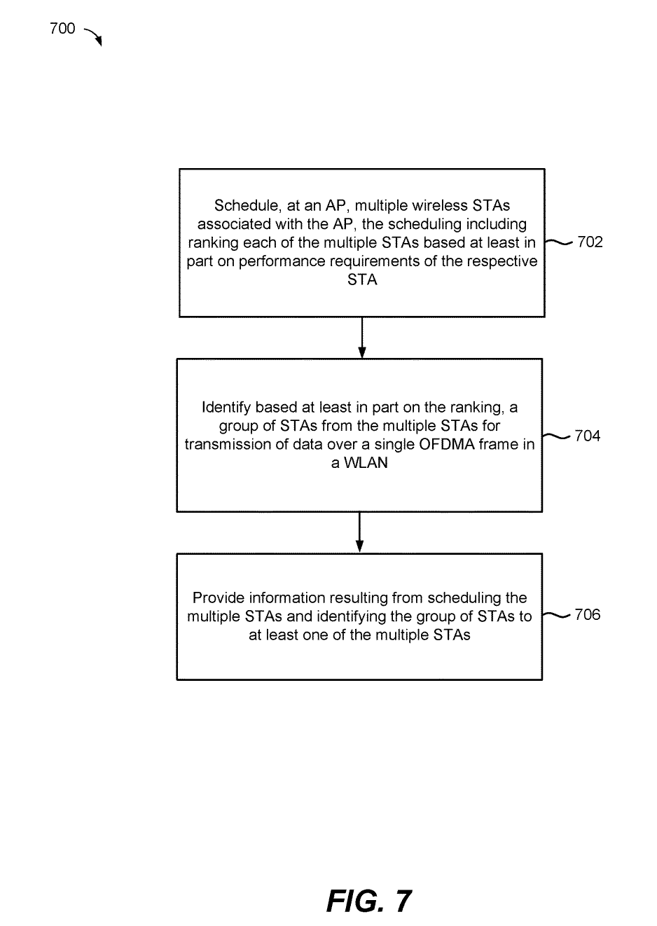

Referring to FIG. 7, an example of one or more operations of an aspect of scheduler component 220 (FIG. 2B) according to the present apparatuses and methods are described with reference to one or more methods and one or more components that may separately schedule and group multiple users during wireless communications. Although the operations described below are presented in a particular order and/or as being performed by an example component, it should be understood that the ordering of the actions and the components performing the actions may be varied, depending on the implementation. Also, although the scheduler component 220 is illustrated as having a number of subcomponents, it should be understood that one or more of the illustrated subcomponent may be separate from, but in communication with, the scheduler component 220 and/or each other. Moreover, it should be understood that the following actions or components described with respect to the scheduler component 220 and/or its subcomponents may be performed by a specially-programmed processor, a processor executing specially-programmed software or computer-readable media, or by any other combination of a hardware component and/or a software component specially configured for performing the described actions or components.

In an aspect, at block 702, method 700 includes scheduling, at an AP, multiple wireless STAs associated with the AP, the scheduling including ranking each of the multiple STAs based at least in part on performance requirements of the respective STA. In an aspect, for example, AP1 105-a may execute scheduler component 220 and performance scheduling component 222 to schedule multiple wireless STAs 115-a, 115-b, 115-d, and 115-e associated with the AP1 105-a, the scheduling including ranking each of the multiple STAs 115-a, 115-b, 115-d, and 115-e based at least in part on performance requirements of the respective STA.

In an aspect, at block 704, method 700 includes identifying, separately from the scheduling and based at least in part on the ranking, a group of STAs from the multiple STAs for transmission of data over a single OFDMA frame in a WLAN. In an aspect, for example, AP1 105-a may execute scheduler component 220 and grouping identifying component 224 to identify, separately from the scheduling and based at least in part on the ranking, a group of STAs from the multiple STAs 115-a, 115-b, 115-d, and 115-e for transmission of data over a single OFDMA frame in a WLAN.

In an aspect, at block 706, method 700 includes providing information to each of the multiple STAs resulting from scheduling the multiple STAs and identifying the group of STAs to at least one of the multiple STAs. In an aspect, for example, AP1 105-a may execute scheduler component 220 and grouping identifying component 224 to provide information to each of the multiple STAs resulting from scheduling the multiple STAs and identifying the group of STAs to at least one of the multiple STAs.

In an aspect, method 700 may further include ranking each of the multiple STAs based at least in part on respective latency requirements, throughput requirements, or a combination thereof. Further, method 700 may include identifying a first subset of the multiple STAs that are higher ranked than a second subset of the multiple STAs in the ranking, and selecting the group of STAs from among the first subset. Additionally, method 700 may include mapping a first scheduling cycle resulting from the ranking of each of the multiple STAs to a second scheduling cycle used by a token-based WRR scheduler, the second scheduling cycle being longer than the first scheduling cycle. In an aspect, the transmission of data over the single OFDMA frame comprises transmission of data using a single PPDU. In an aspect, method 300 includes adjusting one or more of a number of unused time resources, frequency resources, or a combination thereof, associated with the transmission of data over the single OFDMA frame; a number of STAs in the group of STAs; or a length of a PPDU.

Further, method 700 includes wherein identifying the group of STAs comprises selecting the group of STAs by adjusting a length of a PPDU, and wherein adjusting a length of the PPDU comprises identifying an upper bound PPDU length, a lower bound PPDU length, and a target PPDU length; and iteratively performing identifying eligible STAs from the multiple STAs that satisfy an unused resource threshold for the target PPDU length; determining a total number of RUs that the eligible STAs occupy; and setting the target PPDU length to be the upper bound PPDU length in response to a determination that the total number of RUs meets a maximum number of RUs, or setting the target PPDU length to be the lower bound PPDU length in response to a determination that the total number of RUs does not meet the maximum number of RUs. Moreover, method 700 includes wherein identifying the group of STAs comprises selecting the group of STAs by sorting the multiple STAs in accordance to their queue length; selecting the first N sorted STAs as candidate STAs, where N is a maximum number of RUs supported; selecting a PPDU duration from multiple PPDUs durations resulting from an iterative allocation of RUs to different subsets of the candidate STAs; and forming the OFDMA frame based on the selected PPDU duration and corresponding allocation of RUs and subset of candidate STAs.

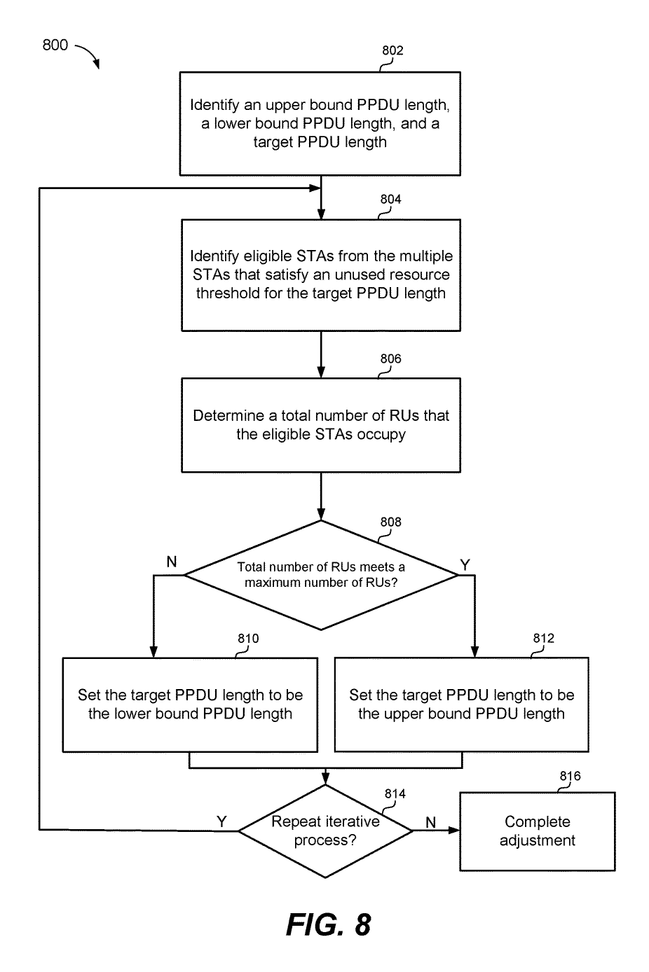

Referring to FIG. 8, an example of one or more operations of an aspect of scheduler component 220 (FIG. 2B) according to the present apparatuses and methods are described with reference to one or more methods and one or more components that may perform bisectional grouping in order to adjust a length of a PPDU for identifying a group of users during wireless communications. Although the operations described below are presented in a particular order and/or as being performed by an example component, it should be understood that the ordering of the actions and the components performing the actions may be varied, depending on the implementation. Also, although the scheduler component 220 is illustrated as having a number of subcomponents, it should be understood that one or more of the illustrated subcomponent may be separate from, but in communication with, the scheduler component 220 and/or each other. Moreover, it should be understood that the following actions or components described with respect to the scheduler component 220 and/or its subcomponents may be performed by a specially-programmed processor, a processor executing specially-programmed software or computer-readable media, or by any other combination of a hardware component and/or a software component specially configured for performing the described actions or components.

In an aspect, at block 802, method 800 includes identifying an upper bound PPDU length, a lower bound PPDU length, and a target PPDU length. In an aspect, for example, AP1 105-a may execute scheduler component 220 and grouping identifying component 224 to identify an upper bound PPDU length, a lower bound PPDU length, and a target PPDU length.

In an aspect, at block 804, method 800 includes identifying eligible STAs from the multiple STAs that satisfy an unused resource threshold for the target PPDU length. In an aspect, for example, AP1 105-a may execute scheduler component 220 and grouping identifying component 224 to identify eligible STAs from the multiple STAs 115-a, 115-b, 115-d, and 115-e that satisfy an unused resource threshold for the target PPDU length.

In an aspect, at block 806, method 800 includes determining a total number of resource units (RUs) that the eligible STAs occupy. In an aspect, for example, AP1 105-a may execute scheduler component 220 and grouping identifying component 224 to determine a total number of resource units (RUs) that the eligible STAs occupy.

In an aspect, at block 808, method 800 includes determining whether the total number of RUs meets a maximum number of RUs. In an aspect, for example, AP1 105-a may execute scheduler component 220 and grouping identifying component 224 to determine whether the total number of RUs meets a maximum number of RUs. If a determination is made that the total number of RUs does not meet a maximum number of RUs, then method 800 proceeds to 810. Otherwise, if a determination is made that the total number of RUs meets a maximum number of RUs, then method 800 proceeds to 812.

In an aspect, at block 810, method 800 includes setting the target PPDU length to be the lower bound PPDU length. In an aspect, for example, AP1 105-a may execute scheduler component 220 and grouping identifying component 224 to set the target PPDU length to be the lower bound PPDU length in response to a determination that the total number of RUs does not meet the maximum number of RUs.

In an aspect, at block 812, method 800 includes setting the target PPDU length to be the upper bound PPDU length. In an aspect, for example, AP1 105-a may execute scheduler component 220 and grouping identifying component 224 to set the target PPDU length to be the upper bound PPDU length in response to a determination that the total number of RUs meets a maximum number of RUs.

In an aspect, at block 814, method 800 includes determining whether to repeat the iterative process in order to properly adjusting the length of the PPDU. If the iterative process is to be repeated then method 800 may return to block 804. Otherwise, if the iterative process is not to be repeated then method 800 may proceed to block 816. In an aspect, at block 816, method 800 includes completing the iterative process and adjustment of the length of the PPDU.

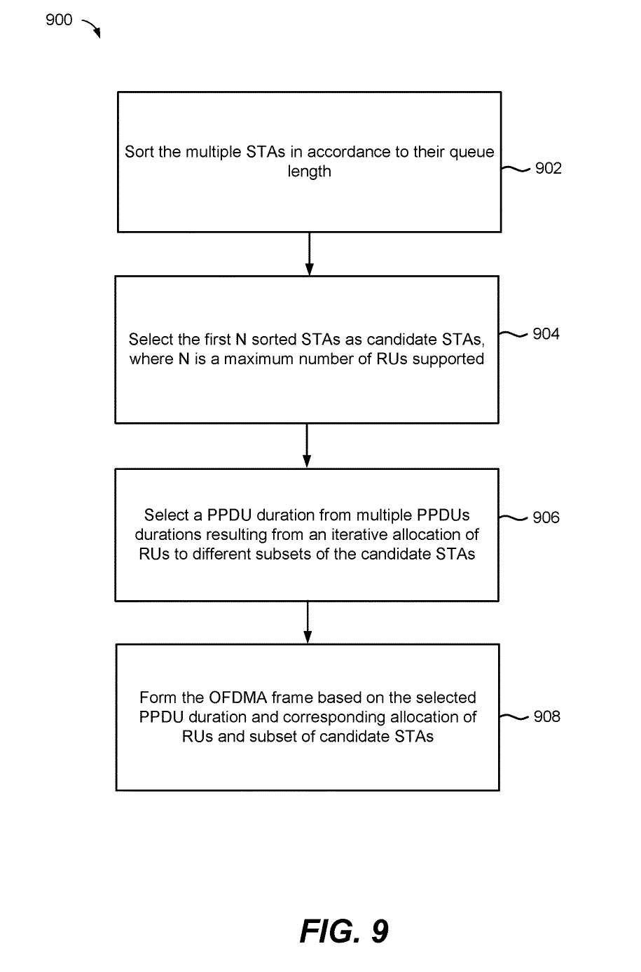

Referring to FIG. 9, an example of one or more operations of an aspect of scheduler component 220 (FIG. 2B) according to the present apparatuses and methods are described with reference to one or more methods and one or more components that may perform proportional resource unit allocation for identifying a group of users during wireless communications. Although the operations described below are presented in a particular order and/or as being performed by an example component, it should be understood that the ordering of the actions and the components performing the actions may be varied, depending on the implementation. Also, although the scheduler component 220 is illustrated as having a number of subcomponents, it should be understood that one or more of the illustrated subcomponent may be separate from, but in communication with, the scheduler component 220 and/or each other. Moreover, it should be understood that the following actions or components described with respect to the scheduler component 220 and/or its subcomponents may be performed by a specially-programmed processor, a processor executing specially-programmed software or computer-readable media, or by any other combination of a hardware component and/or a software component specially configured for performing the described actions or components.

In an aspect, at block 902, method 900 includes sorting the multiple STAs in accordance to their queue length. In an aspect, for example, AP1 105-a may execute scheduler component 220 and grouping identifying component 224 to sort the multiple STAs 115-a, 115-b, 115-d, and 115-e in accordance to their queue length.

In an aspect, at block 904, method 900 includes selecting the first N sorted STAs as candidate STAs, where N is a maximum number of RUs supported. In an aspect, for example, AP1 105-a may execute scheduler component 220 and grouping identifying component 224 to select the first N sorted STAs as candidate STAs, where N is a maximum number of RUs supported.

In an aspect, at block 906, method 900 includes selecting a PPDU duration from multiple PPDUs durations resulting from an iterative allocation of RUs to different subsets of the candidate STAs. In an aspect, for example, AP1 105-a may execute scheduler component 220 and grouping identifying component 224 to select a PPDU duration from multiple PPDUs durations resulting from an iterative allocation of RUs to different subsets of the candidate STAs.

In an aspect, at block 908, method 900 includes forming the OFDMA frame based on the selected PPDU duration and corresponding allocation of RUs and subset of candidate STAs. In an aspect, for example, AP1 105-a may execute scheduler component 220 and grouping identifying component 224 to form the OFDMA frame based on the selected PPDU duration and corresponding allocation of RUs and subset of candidate STAs.

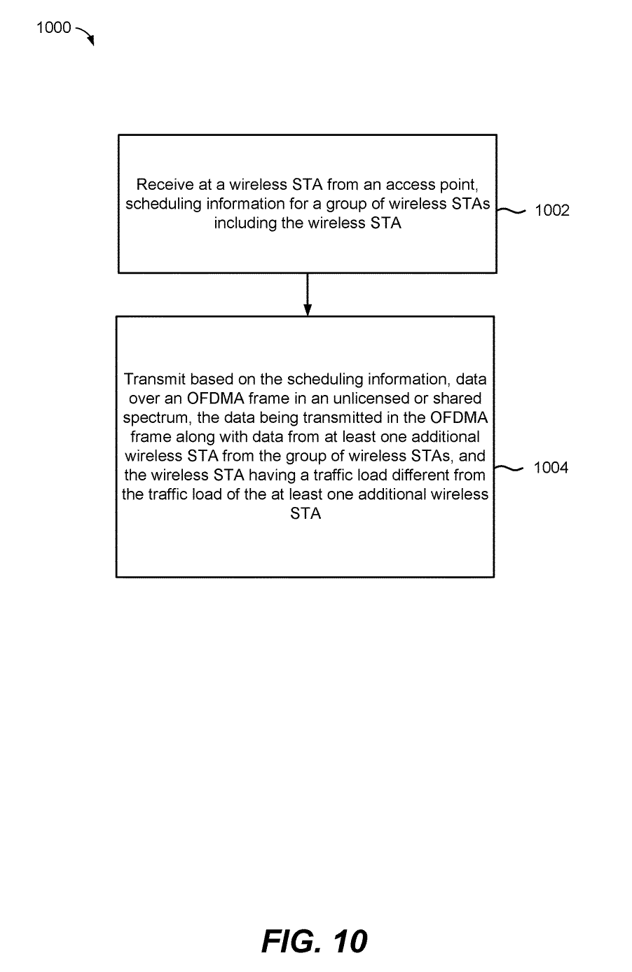

Referring to FIG. 10, an example of one or more operations of an aspect of an STA, such as one or more of STAs 115-a, 115-b, 115-d, and 115-e (FIG. 2B) according to the present apparatuses and methods are described with reference to one or more methods and one or more components that may perform communicating in a WLAN based on information corresponding to a scheduling and grouping of multiple users. Although the operations described below are presented in a particular order and/or as being performed by an example component, it should be understood that the ordering of the actions and the components performing the actions may be varied, depending on the implementation. Also, although the STA is illustrated as having a number of subcomponents, it should be understood that one or more of the illustrated subcomponent may be separate from, but in communication with, the STA and/or each other. Moreover, it should be understood that the following actions or components described with respect to the STA and/or its subcomponents may be performed by a specially-programmed processor, a processor executing specially-programmed software or computer-readable media, or by any other combination of a hardware component and/or a software component specially configured for performing the described actions or components.

In an aspect, at block 1002, method 1000 includes receiving at a wireless STA from an access point, scheduling information for a group of wireless STAs including the wireless STA. In an aspect, for example, STA 115-a and/or a processor may execute a transceiver to receive from an AP, such as AP1 105-a, scheduling information for a group of wireless STAs including STA 115-a.

In an aspect, at block 1004, method 1000 includes transmitting based on the scheduling information, data over an OFDMA frame in a WLAN, the data being transmitted in the OFDMA frame along with data from at least one additional wireless STA from the group of wireless STAs, and the wireless STA having a traffic load different from the traffic load of the at least one additional wireless STA. In an aspect, for example, STA 115-a and/or a processor may execute a transceiver to transmit based on the scheduling information, data over an OFDMA frame in a WLAN, the data being transmitted in the OFDMA frame along with data from at least one additional wireless STA from the group of wireless STAs, and the wireless STA 115-a having a traffic load different from the traffic load of the at least one additional wireless STA.

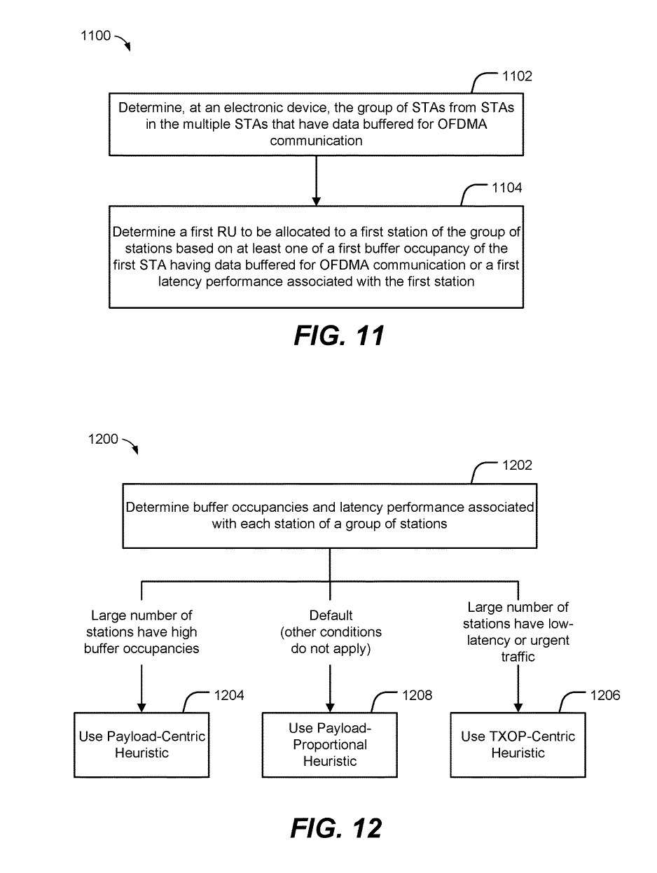

Referring to FIGS. 11 and 12, illustrative aspects of method for allocating resources are shown in relation to block 704 of FIG. 7 above. Referring to FIG. 11, an illustrative aspect of a method 1100 of allocating resources is shown. In particular examples, the method 1100 may be performed by the AP1 105-a of FIG. 2C.

In an aspect, at block 1102, method 1100 may include determining, at an access point, the group of STAs from STAs in the multiple STAs that have data buffered for OFDMA communication. For example, in the case of DL operation, the buffered data may include first data stored in the first DL buffer 240 for the first STA 115-a of FIG. 2C. As another example, in the case of UL operation, the buffered data may include data stored in the UL buffer 256 at the first STA 115-a. In particular aspects, the group of STAs may correspond to an OFDMA group, and a number of STAs included in the OFDMA group may be determined based on a dynamically tunable grouping parameter, such as the grouping parameter alpha described with reference to FIGS. 2C, 3A-3C, and 4-6.

In an aspect, at block 1104, method 1100 may also include determining a first RU to be allocated to a first STA of the group of STAs based on at least one of a first buffer occupancy of the first STA having data buffered for OFDMA communication or a first latency performance associated with the first STA. The RUs may correspond to frequency subcarriers of a wireless channel, such as a wireless channel operating in accordance with an IEEE 802.11ax specification. For example, referring to FIG. 2C, the AP1 105-a may allocate a RU in which to transmit the first data stored in the first DL buffer 240 based on a buffer occupancy of the first DL buffer 240 and/or a first latency performance associated with the first STA 115-a. As another example, the AP1 105-a may allocate a RU in which the first STA 115-a can transmit UL data stored in the first UL buffer 256 based on a buffer occupancy of the first UL buffer 256 and/or a latency performance associated with the first STA 115-a. In particular aspects, the latency performance may impact a size of the RU. To illustrate, the size of the RU may be based at least in part on a service flag associated with the first STA, an access delay profile associated with the first STA, whether the buffered data associated with the first STA is urgent or high-priority, etc.

In some examples, the method 1100 also includes identifying additional data that is buffered for OFDMA communication with respect to a second STA of the group of STAs and determining a second RU to be allocated to the second STA. The first and second RUs may correspond to a single wireless transmission. When the wireless transmission is an UL transmission, the wireless transmission may include data transmitted from one or more STAs of the group of STAs. When the wireless transmission is a DL transmission, the wireless transmission may include data transmitted to one or more STAs of the group of STAs.

In particular aspects, the RU allocations for the STAs are performed based on selecting and applying at least a portion of a heuristic. For example, FIG. 12 illustrates a particular aspect of a method 1200 of selecting a heuristic for RU allocation. In an illustrative example, the method 1200 may be performed by the AP1 105-a. Alternatively, or in addition, the method 1200 may be performed between blocks 1102 and 1104 of the method 1100 of FIG. 11.

In an aspect, method 1200 may include determining buffer occupancies and latency performance associated with each STA of a group of STAs. In some examples, the group of STAs may have been determined based on the adjustable grouping parameter alpha described with reference to FIGS. 2C, 3A-3C, and 4-6.

In an aspect, when a large number of STAs have high buffer occupancies, the method 600 may include using a payload-centric heuristic, at 1204. For example, the payload-centric heuristic 132 of FIG. 2C may be used when a large number of STAs in the coverage area 110-a have high buffer occupancies. In another aspect, when a large number of STAs have low-latency or urgent traffic, the method 1200 may include using a TXOP-centric heuristic, at 1206. For example, the TXOP-centric heuristic 234 of FIG. 2C may be used when a large number of STAs in the coverage area 110-a have low-latency data awaiting transmission. In a further aspect, when neither of the above conditions applies, the method 1200 may include using a payload-proportional heuristic by default, at 1208. For example, the payload-proportional heuristic 236 of FIG. 2C may be used.

In some examples, the number of STAs included in the OFDMA group to be served during the TXOP may be dynamic. For example, the tunable parameter alpha described above may be used to determine how many STAs should be included in the OFDMA group during application of the payload-centric, TXOP-centric, or payload-proportional heuristic. Using the tunable parameter alpha may thus make each of the heuristics adaptive based on throughput, access delay, and/or channel conditions (e.g., flat vs. frequency selective).

Various processes described herein, such as the processes shown in the methods of FIGS. 11-12, may be controlled by a processing unit such as a central processing unit (CPU), a controller, a field-programmable gate array (FPGA) device, an application-specific integrated circuit (ASIC), another hardware device, firmware device, or any combination thereof. As an example, the method 500 of FIG. 5, the method 1200 of FIG. 12, or a combination thereof, can be performed by one or more processors that execute instructions to determine an unusable channel time. Additionally, a first portion of one of the methods of FIGS. 11-12 may be combined with at least a second portion of the same or another one of the methods of FIGS. 11-12. Moreover, in particular aspects, steps may be performed in a different order than shown in FIGS. 11-12.

In some aspects, an apparatus or any component of an apparatus may be configured to (or operable to or adapted to) provide functionality as taught herein. This may be achieved, for example: by manufacturing (e.g., fabricating) the apparatus or component so that it will provide the functionality; by programming the apparatus or component so that it will provide the functionality; or through the use of some other suitable implementation technique. As one example, an integrated circuit may be fabricated to provide the requisite functionality. As another example, an integrated circuit may be fabricated to support the requisite functionality and then configured (e.g., via programming) to provide the requisite functionality. As yet another example, a processor circuit may execute code to provide the requisite functionality.

It should be understood that any reference to an element herein using a designation such as “first,” “second,” and so forth does not generally limit the quantity or order of those elements. Rather, these designations may be used herein as a convenient method of distinguishing between two or more elements or instances of an element. Thus, a reference to first and second elements does not mean that only two elements may be employed there or that the first element must precede the second element in some manner. Also, unless stated otherwise a set of elements may comprise one or more elements. In addition, terminology of the form “at least one of A, B, or C” or “one or more of A, B, or C” or “at least one of the group consisting of A, B, and C” used in the description or the claims means “A or B or C or any combination of these elements.” For example, this terminology may include A, or B, or C, or A and B, or A and C, or A and B and C, or 2A, or 2B, or 2C, and so on.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The methods, sequences and/or algorithms described in connection with the aspects disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor.

Accordingly, an aspect of the disclosure can include a computer readable medium embodying a method for dynamic bandwidth management for transmissions in unlicensed spectrum. Accordingly, the disclosure is not limited to the illustrated examples.

While the foregoing disclosure shows illustrative aspects, it should be noted that various changes and modifications could be made herein without departing from the scope of the disclosure as defined by the appended claims. The functions, steps and/or actions of the method claims in accordance with the aspects of the disclosure described herein need not be performed in any particular order. Furthermore, although certain aspects may be described or claimed in the singular, the plural is contemplated unless limitation to the singular is explicitly stated.

What is claimed is:

1. A method for wireless communications, comprising:
scheduling, at an access point (AP), multiple wireless stations (STAs) associated with the AP, the scheduling including ranking each of the multiple STAs based at least in part on performance requirements of the respective STA;
identifying, based at least in part on the ranking, a group of STAs from the multiple STAs for transmission of data over a single orthogonal frequency-division multiple access (OFDMA) frame in a wireless local area network (WLAN); and
providing information resulting from scheduling the multiple STAs and identifying the group of STAs to at least one of the multiple STAs.

2. The method of claim 1, wherein identifying the group of STAs comprises:
determining, at the AP, the group of STAs from STAs in the multiple STAs that have data buffered for OFDMA communication; and
determining a first resource unit (RU) to be allocated to a first STA of the group of STAs based on at least one of a first buffer occupancy of the first STA having data buffered for OFDMA communication or a first latency performance associated with the first STA.

3. The method of claim 2, wherein the first RU corresponds to frequency subcarriers of a wireless channel.

4. The method of claim 2, wherein a number of STAs included in the group of STAs is based at least in part on a grouping parameter.

5. The method of claim 2, further comprising adjusting the grouping parameter based on one or more service flags associated with the group of STAs, a service flag threshold, one or more access delay profiles associated with the group of STAs, or any combination thereof.

6. The method of claim 2, further comprising determining a size of the first RU to be allocated to the first STA based on the first buffer occupancy associated with the first STA and a first data rate associated with the first STA.

7. The method of claim 6, wherein the size of the first RU is proportional to at least one of the first buffer occupancy associated with the first STA or a square root of the first buffer occupancy.

8. The method of claim 2, wherein the first latency performance is based at least in part on whether buffered data associated with the first STA is awaiting transmission for a threshold period of time, a service flag associated with the first STA, or an access delay profile associated with the first STA.

9. The method of claim 2, wherein determining the first RU further comprises performing at least one of:
determining RU sizes for one or more STAs including the first STA of the group of STAs based on an amount of buffered data associated with each of the one or more STAs having data buffered for OFDMA communication;
allocating an RU to each of the one or more STAs based on the RU sizes; and
determining a physical layer convergence protocol (PLCP) protocol data unit (PPDU) length of a transmission based on the allocated RUs.

10. The method of claim 2, wherein determining the first RU further comprises:
assigning an RU size to each of one or more STAs including the first STA of the group of STAs, the RU size corresponding to a first RU size;
adjusting the RU size for each of the one or more STAs on a per-STA basis while each of the one or more STAs is accommodated in a transmission;
allocating an RU to each of the one or more STAs; and
determining a physical layer convergence protocol (PLCP) protocol data unit (PPDU) length of the transmission based on the allocated RUs.

11. The method of claim 2, wherein determining the first RU further comprises:
determining target RU sizes for one or more STAs of the group of STAs based on an amount of buffered data associated with each of the one or more STAs having data buffered for OFDMA communication;
determining RU sizes for the one or more STAs based on the target RU sizes, wherein the RU size for a particular STA is based on a ratio of the target RU size for the STA and a sum of all of the target RU sizes;
allocating an RU to each of the one or more STAs based on the RU sizes; and
determining a physical layer convergence protocol (PLCP) protocol data unit (PPDU) length of a transmission based on the allocated RUs.

12. The method of claim 2, further comprising:
identifying additional data that is buffered for OFDMA communication with respect to a second STA of the group of STAs; and
determining a second RU to be allocated to the second STA.

13. The method of claim 1, wherein ranking each of the multiple STAs based at least in part on performance requirements of the respective STA comprises ranking each of the multiple STAs based at least in part on respective latency requirements, throughput requirements, or a combination thereof.

14. The method of claim 1, wherein the transmission of data over the single OFDMA frame comprises transmission of data using a single physical layer convergence procedure (PLCP) protocol data unit (PPDU).

15. An apparatus for wireless communication, comprising:
a memory that stores instructions; and
at least one processor coupled with the memory, wherein the at least one processor and the memory are configured to:
schedule, at an access point (AP), multiple wireless stations (STAs) associated with the AP, the scheduling including ranking each of the multiple STAs based at least in part on performance requirements of the respective STA;
identify based at least in part on the ranking, a group of STAs from the multiple STAs for transmission of data over a single orthogonal frequency-division multiple access (OFDMA) frame in spectrum wireless local area network (WLAN); and
provide information to each of the multiple STAs resulting from scheduling the multiple STAs and identifying the group of STAs to at least one of the multiple STAs.

16. The apparatus of claim 15, wherein the processor configured to identify the group of STAs is further configured to:
determine, at the AP, the group of STAs from STAs in the multiple STAs that have data buffered for OFDMA communication; and
determine a first resource unit (RU) to be allocated to a first STA of the group of STAs based on at least one of a first buffer occupancy of the first STA having data buffered for OFDMA communication or a first latency performance associated with the first STA.

17. The apparatus of claim 16, wherein the first RU corresponds to frequency subcarriers of a wireless channel.

18. The apparatus of claim 16, wherein a number of STAs included in the group of STAs is based at least in part on a grouping parameter.

19. The apparatus of claim 16, wherein the processor is further configured to adjust the grouping parameter based on one or more service flags associated with the group of STAs, a service flag threshold, one or more access delay profiles associated with the group of STAs, or any combination thereof.

20. The apparatus of claim 16, wherein the processor is further configured to determine a size of the first RU to be allocated to the first STA based on the first buffer occupancy associated with the first STA and a first data rate associated with the first STA.

21. The apparatus of claim 20, wherein the size of the first RU is proportional to at least one of the first buffer occupancy associated with the first STA or a square root of the first buffer occupancy.

22. The apparatus of claim 16, wherein the first latency performance is based at least in part on whether buffered data associated with the first STA is awaiting transmission for a threshold period of time, a service flag associated with the first STA, or an access delay profile associated with the first STA.

23. The apparatus of claim 16, wherein the processor configured to determine the first RU is further configured to:
determine RU sizes for one or more STAs including the first STA of the group of STAs based on an amount of buffered data associated with each of the one or more STAs having data buffered for OFDMA communication;
allocate an RU to each of the one or more STAs based on the RU sizes; and
determine a physical layer convergence protocol (PLCP) protocol data unit (PPDU) length of a transmission based on the allocated RUs.

24. The apparatus of claim 16, wherein the processor configured to determine the first STA is further configured to:
assign an RU size to each of one or more STAs including the first STA of the group of STAs, the RU size corresponding to a first RU size;
adjust the RU size for each of the one or more STAs on a per-STA basis while each of the one or more STAs is accommodated in a transmission;
allocate an RU to each of the one or more STAs; and
determine a physical layer convergence protocol (PLCP) protocol data unit (PPDU) length of the transmission based on the allocated RUs.

25. The apparatus of claim 16, wherein the processor configured to determine the first STA is further configured to:
determine target RU sizes for one or more STAs of the group of STAs based on an amount of buffered data associated with each of the one or more STAs having data buffered for OFDMA communication;
determine RU sizes for the one or more STAs based on the target RU sizes, wherein the RU size for a particular STA is based on a ratio of the target RU size for the STA and a sum of all of the target RU sizes;
allocate an RU to each of the one or more STAs based on the RU sizes; and
determine a physical layer convergence protocol (PLCP) protocol data unit (PPDU) length of a transmission based on the allocated RUs.

26. The apparatus of claim 16, wherein the processor is further configured:
identify additional data that is buffered for OFDMA communication with respect to a second STA of the group of STAs; and
determine a second RU to be allocated to the second STA.

27. The apparatus of claim 15, wherein the processor configured to rank each of the multiple STAs based at least in part on performance requirements of the respective STA is further configured to rank each of the multiple STAs based at least in part on respective latency requirements, throughput requirements, or a combination thereof.

28. The apparatus of claim 15, wherein the transmission of data over the single OFDMA frame comprises transmission of data using a single physical layer convergence procedure (PLCP) protocol data unit (PPDU).

29. A computer-readable medium storing computer executable code, comprising:
code for scheduling, at an access point (AP), multiple wireless stations (STAs) associated with the AP, the scheduling including ranking each of the multiple STAs based at least in part on performance requirements of the respective STA;
code for identifying based at least in part on the ranking, a group of STAs from the multiple STAs for transmission of data over a single orthogonal frequency-division multiple access (OFDMA) frame in spectrum wireless local area network (WLAN); and
code for providing information to each of the multiple STAs resulting from scheduling the multiple STAs and identifying the group of STAs to at least one of the multiple STAs.

30. An apparatus for wireless communication, comprising:
means for scheduling, at an access point (AP), multiple wireless stations (STAs) associated with the AP, the scheduling including ranking each of the multiple STAs based at least in part on performance requirements of the respective STA;
means for identifying based at least in part on the ranking, a group of STAs from the multiple STAs for transmission of data over a single orthogonal frequency-division multiple access (OFDMA) frame in spectrum wireless local area network (WLAN); and
means for providing information to each of the multiple STAs resulting from scheduling the multiple STAs and identifying the group of STAs to at least one of the multiple STAs.
